(19) United States
(12) Patent Application Publication
(10) Pub. No.: US 2026/0126460 A1
(43) Pub. Date: May 7, 2026

(54) LABORATORY ANALYZERS AND METHODS OF PERFORMING STUDIES USING LABORATORY ANALYZERS

(71) Applicant: Siemens Healthcare Diagnostics Inc., Tarrytown, NY (US)

(72) Inventors: Susan Bertuccelli, Graham, NC (US); Julia Seltmann, Coloma, MI (US); Christine Venart, Morristown, NJ (US); Ganesh Pandiyan Subburam, Bridgewater, NJ (US)

(73) Assignee: Siemens Healthcare Diagnostics Inc., Tarrytown, NY (US)

(21) Appl. No.: 18/686,379

(22) PCT Filed: Sep. 9, 2022
(86) PCT No.: PCT/US2022/076214

§ 371 Date: Feb. 23, 2024

Related U.S. Application Data
(60) Provisional application No. 63/242,897, filed on Sep. 10, 2021.

(51) Int. Cl. G01N 35/00

(52) U.S. Cl. CPC G01N 35/00693; G01N 35/00871; G01N 2035/00653; G01N 2035/0091

(57) ABSTRACT

A method of performing a study using one or more laboratory analyzers includes displaying on a display one or more evaluation studies performable on the one or more laboratory analyzers; receiving a selected evaluation study to be performed on the one or more laboratory analyzers from the one or more evaluation studies; generating, by a processor, instructions configured to operate the one or more laboratory analyzers to perform the evaluation study; and executing the instructions in the one or more laboratory analyzers. The instructions cause the one or more laboratory analyzers to perform an analysis using one or more test materials in response to the selected evaluation study. Other methods and apparatus are disclosed.

### CROSS REFERENCE TO RELATED APPLICATION

This application claims the benefit of U.S. Provisional Patent Application No. 63/242,897, entitled “LABORATORY ANALYZERS AND METHODS OF PERFORMING STUDIES USING LABORATORY ANALYZERS” filed Sep. 10, 2021, the disclosure of which is hereby incorporated by reference in its entirety for all purposes.

### FIELD

Embodiments of the disclosure relate to performing studies using laboratory analyzers.

### BACKGROUND

Laboratory analyzers perform assays on biological samples obtained from patients. The biological samples may be liquids, for example, taken from the patients. Prior to performing certain analyses, the laboratory analyzers may need to be calibrated by analyzing known chemicals (calibrators) and comparing the results from the analyses to predetermined values. In addition, reagents used during the analyses may need to be tested to determine whether the reagents are in proper condition to perform the analyses.

Methods and devices for determining whether the calibrators and reagents are suitable for performing the analyses are sought.

### SUMMARY

According to a first aspect, a method of performing a study using one or more laboratory analyzers is provided. The method includes displaying on a display one or more evaluation studies performable on the one or more laboratory analyzers; receiving a selected evaluation study to be performed on the one or more laboratory analyzers from the one or more evaluation studies; generating, by a processor, instructions configured to operate the one or more laboratory analyzers to perform the evaluation study; and executing the instructions in the one or more laboratory analyzers, wherein the instructions cause the one or more laboratory analyzers to perform an analysis on one or more test materials in response to the selected evaluation study.

According to a second aspect, a laboratory system is provided. The laboratory system includes: one or more laboratory analyzers; a display; and a controller. The controller is configured to: generate instructions to display on the display one or more evaluation studies performable on the one or more laboratory analyzers; receive user input selecting an evaluation study to be performed on the one or more laboratory analyzers from the one or more evaluation studies; generate instructions configured to operate the one or more laboratory analyzers to perform the evaluation study; and execute the instructions in the one or more laboratory analyzers. The instructions cause the one or more laboratory analyzers to perform an analysis on one or more test materials in response to the selected evaluation study.

In another aspect, a method of performing a study using one or more laboratory analyzers is provided. The method includes displaying via a graphical user interface one or more evaluation studies performable on the one or more laboratory analyzers; receiving a selected evaluation study to be performed on the one or more laboratory analyzers from the one or more evaluation studies displayed via the graphical user interface; generating, by a processor, instructions configured to operate the one or more laboratory analyzers to perform the evaluation study; and executing the instructions in the one or more laboratory analyzers. The instructions cause the one or more laboratory analyzers to perform an analysis on a reagent, a quality control material, or a calibrator in response to the selected evaluation study. The method also includes generating a report in response to the analysis.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure. This disclosure is intended to cover all modifications, equivalents, and alternatives falling within the scope of the claims (appended further below).

### BRIEF DESCRIPTION OF THE DRAWINGS

The drawings, described below, are for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1 illustrates a block diagram of a laboratory system including a plurality of laboratory analyzers, instruments, and a controller according to one or more embodiments.

FIG. 2 illustrates a block diagram of the controller of FIG. 1 and interactions between the controller and the analyzers according to one or more embodiments.

FIG. 3 illustrates a flowchart of a method of using a controller in a laboratory system to generate one or more studies according to one or more embodiments.

FIG. 4 illustrates a graphical user interface (GUI) requesting a user to select a study to be performed by a controller on at least one analyzer according to one or more embodiments.

FIG. 5A illustrates a GUI enabling a user of a laboratory system to input preliminary information into a controller to run a calibrator lot comparison study according to one or more embodiments.

FIG. 5B illustrates a GUI that may be displayed following the GUI of FIG. 5A and is configured to receive parameters for running the calibrator lot comparison study according to one or more embodiments.

FIG. 5C illustrates a GUI that may be displayed following the GUI of FIG. 5B and is configured to receive new sample identifications for running the calibrator lot comparison study according to one or more embodiments.

FIG. 5D illustrates a GUI configured to receive existing sample identifications for running the calibrator lot comparison study of FIG. 5A according to one or more embodiments.

FIG. 5E illustrates a display showing results of a calibrator lot comparison study according to one or more embodiments.

FIG. 6A illustrates a GUI enabling a user of a laboratory system to input preliminary information into a controller for running a quality control (QC) parallel study according to one or more embodiments.

FIG. 6B illustrates a GUI enabling a user of a laboratory system to input assays into a controller for running the QC parallel study of FIG. 6A according to one or more embodiments.

FIG. 6C illustrates a display showing results of a QC parallel study according to one or more embodiments.

FIG. 7A illustrates a GUI enabling a user of a laboratory system to input preliminary information into a controller for running a reagent lot comparison study according to one or more embodiments.

FIG. 7B illustrates a display showing results of the reagent comparison lot comparison study of FIG. 7A according to one or more embodiments.

FIG. 8A illustrates a GUI enabling a user of a laboratory system to input preliminary information into a controller for running an automatic measuring interval verification (MIV) study according to one or more embodiments.

FIG. 8B illustrates a GUI enabling a user to input additional information into a controller for running the automatic MIV study of FIG. 8A according to one or more embodiments.

FIG. 8C illustrates a display showing results of the automatic MIV study of FIG. 8A according to one or more embodiments.

FIG. 9A illustrates a GUI enabling a user of a laboratory system to input information into a controller for running a manual MIV study according to one or more embodiments.

FIG. 9B illustrates a display showing results of the manual MIV study of FIG. 9A according to one or more embodiments.

FIG. 10A illustrates a GUI enabling a user of a laboratory system to input information into a controller for running a simple precision study according to one or more embodiments.

FIG. 10B illustrates a display showing results of the simple precision study of FIG. 10A according to one or more embodiments.

FIG. 11 illustrates a flowchart of a method of performing a study using a laboratory analyzer according to one or more embodiments.

FIG. 12 illustrates a flowchart of another method of performing a study using a laboratory analyzer according to one or more embodiments.

### DETAILED DESCRIPTION

Laboratory systems include analyzers that conduct assays to identify analytes or other constituents in biological samples. The biological samples are typically stored in sample containers wherein the sample containers are transported to specific analyzers to perform specific assays (e.g., tests). For example, each of the analyzers may perform different assays. Accordingly, the biological samples are transported to the specific analyzers that are configured to perform the assays required on specific samples.

Some assays require preprocessing of the samples prior to performing the assays. Preprocessing may include diluting the samples and adding specific chemicals (e.g., test materials), for example. The test materials may include reagents or other chemicals.

The assays may include photo analyses or other analyses performed on the samples to test for analytes and/or other properties of the samples. In some embodiments, the analyses may involve reactions that generate changes, such as fluorescence or luminescence emissions, that may be analyzed to determine a presence and/or a concentration of an analyte or other constituent contained in the samples. Some analyzers may include one or more sensors, such as one or more imaging devices coupled to a controller (e.g., a computer), wherein the computer analyzes image data generated by the one or more imaging devices to determine the concentration and/or presence of analytes or other constituents.

One or more of the analyzers may be automated, meaning that robots and other mechanical/electrical devices in the analyzers may be operated to automatically perform the assays. For example, the specimen containers may be moved automatically between stations, such as preprocessing stations and analyzers, within the laboratory systems. Robots may move the samples and/or the sample containers into and from the analyzers. Other robotic devices may add testing materials to the samples and perform the assays described herein.

Before performing assays, the analyzers may be calibrated using known test materials (e.g., calibration materials). A properly functioning analyzer will provide a predetermined analysis result in response to analyzing the calibration materials. In some embodiments, the analyzer may be adjusted so that the results provided by analyzing the calibration materials are within a predetermined range. In some embodiments, the calibration materials may be test materials on which one or more of the studies described herein are performed.

While performing assays, the analyzers may use a substantial amount of test materials. The test materials include, but are not limited to, calibration chemicals, reagents, and materials other than unmodified samples that are used by the analyzers. These test materials should have properties that are within rigid specifications to assure that the analyses are accurate. In some embodiments, test materials from different lots may differ enough to affect the analyses. In some embodiments, properties of the test materials may change as a function of time, so a newer test material may provide different analysis results than an older test material. In other embodiments, the test materials may react differently within different analyzers. For example, as sensors in a first analyzer age, the results of analyses generated by the first analyzer may differ from results of analyses generated by a second analyzer.

In some jurisdictions, studies of the test materials and/or analyzer performance using the test materials may have to be generated for regulatory compliance. Unlike analyses performed on the samples, the studies analyze the test materials and/or analyzer performance using the test materials. For example, the studies may analyze (e.g., test) the calibration materials, reagents, and other materials used by the analyzers. Conventional analyzers and laboratory systems perform the studies manually, which is time consuming. For example, a user of a laboratory system may manually test the test materials to generate the studies.

In addition, users of conventional analyzers have to repurpose patient ordering functions to process samples for studies (e.g., evaluations). Thus, the samples used for the studies are treated as patient samples by the analyzers in conventional systems, which restricts or limits patient testing (assays). The restrictions may include repeating critical values and triggering dilutions at a measuring interval limit, which may prevent a user from evaluating the performances of the assays. The result is that the user may be busy testing the limits of the measuring intervals and generating statistics relevant to studies instead of performing assays.

In addition to the foregoing, the conventional studies are done manually such as on a secondary desktop computer or on a printed hard copy. Thus, during the generation of the studies, the user of the analyzers is not performing analyses on patient samples. Therefore, more efficient study generation methods along with analyzers and laboratory systems that provide more efficient studies are sought.

The laboratory systems, analyzers, and methods disclosed herein provide more efficient studies than conventional laboratory systems, analyzers, and methods. Data from one or more analyzers or from a laboratory system may be used to identify samples and test materials that meet criteria for specific studies. Tests used to generate a study may be run on an analyzer in the background while the analyzer is performing routine assays. In some embodiments, the studies may be pre-configured and provided with one or more analyzers or with the laboratory system. In some embodiments, the studies may be user-defined and saved for later use. In some embodiments, previously determined study criteria may be modifiable within software to allow a user to customize one or more studies to specific needs or preferences.

When a study is complete, the data generated by the study may be consolidated by a controller of the laboratory system or one or more analyzers into a report (e.g., a study report) and the user may be notified that the report is available for review. Data may also be saved in a library (e.g., computer memory or databases) so past reports can be conveniently accessed in the future. In some embodiments, data from different studies may be compared to track trends and for other purposes. In some embodiments, the data from the studies may be accessed during regulatory inspections, such as to evaluate new test materials.

An example of one of the studies is a reagent comparison study that may be performed by a controller when loading a new lot of reagent into an analyzer. The study may also be used when an assay is moved from one analyzer to another analyzer. In other embodiments, the study may be used to compare analyses from any two individual packs of reagent for any reason such as troubleshooting biases in test results. Thus, in some embodiments, the study may compare two different reagents. The reagent comparison study may compare performance of a first reagent, such as from a first lot, to the performance of a second reagent, such as from a second lot. If the difference between the performances is greater than a predetermined difference, one of the two reagents may be defective. In some embodiments, an investigation can be initiated to find the root cause of a difference identified by a study. In some embodiments, the difference may be expected, such as when an antibody pool in raw materials is changed by the reagent manufacturer or when a hardware problem occurs when comparing different reagents materials on different analyzers. The analyzers, systems, and methods described herein provide the user with an easy way to perform regular spot checks (e.g., spot studies) to identify problems.

In some embodiments, the studies described herein, including the reagent comparison study, enable a user to select between new sample identifications (SIDs) or existing SIDs. Thus, the studies described herein provide for capturing appropriate samples (existing SIDs) out of routine runs (assays) in the analyzer. The use of existing SIDs is less time consuming for the user, which under conventional methods and analyzers, would need to select these samples manually from storage along with historical test result reviews.

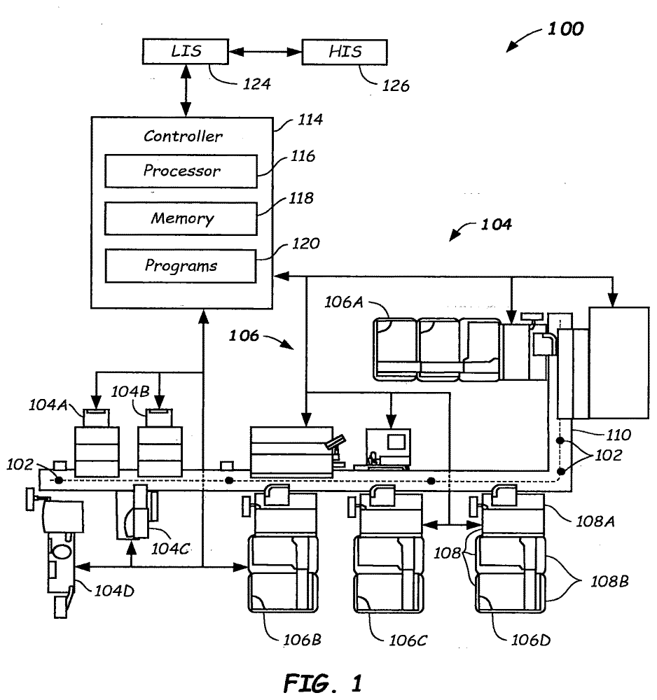

These and other laboratory systems, analyzers, instruments, methods, and programs are described herein with reference to FIGS. 1-12.

Reference is now made to FIG. 1, which illustrates a block diagram of a laboratory system 100 configured to perform assays (e.g., tests) on biological samples (e.g., biofluids). The samples may include blood serum, urine, and other materials obtained from patients. The samples are collected from the patients and stored in sample containers 102 (a few labelled), which are configured to be transported throughout the laboratory system 100. Test orders, which include tests and assays that are to be performed on the samples, may be received electronically in the laboratory system 100 as described herein.

The laboratory system 100 may include a plurality of laboratory analyzers, which are referred to herein as analyzers 104. The analyzers 104 may process the sample containers 102 and/or perform assays on specimens located in the sample containers 102. In some embodiments, a plurality of the analyzers 104 may be implemented as instruments 106 that contain analyzers and/or other modules. In the embodiment of FIG. 1, the laboratory system 100 includes four instruments 106, which are referred to individually as a first instrument 106A, a second instrument 106B, a third instrument 106C, and a fourth instrument 106D. The instruments 106 may each include one or more analyzers and/or one or more other modules. The other modules may be configured to perform preprocessing procedures on the samples, for example.

Reference is made to the fourth instrument 106D, which may be similar or identical to the other instruments. The fourth instrument 106D may include three modules 108, which may include a processing module 108A and two analyzers 108B. The processing module 108A may prepare samples for testing and/or may identify sample containers 102 received in the fourth instrument 106D. The processing module 108A may be configured to perform other functions. The analyzers 108B may perform assays on the samples located in the sample containers 102.

Some of the analyzers 104 may be individual or standalone analyzers. In the embodiment of FIG. 1, the laboratory system 100 may include four such analyzers, which are referred to individually as a first analyzer 104A, a second analyzer 104B, a third analyzer 104C, and a fourth analyzer 104D. Different ones of the analyzers 104 may be configured to perform different assays on the samples located in the sample containers 102.

The laboratory system 100 may include a track 110 configured to transport the sample containers 102 or enable transport of the sample containers 102 to and from the analyzers 104 and/or instruments 106 in the laboratory system 100. The track 110 may include, for example, a railed track (e.g., a monorail or a multiple rail), a collection of conveyor belts, conveyor chains, moveable platforms, magnetic transportation, or any other suitable type of conveyance mechanism. In some embodiments, the sample containers 102 may be coupled to self-propelled devices (not shown), such as linear motors, that travel on the track 110.

The laboratory system 100 may include a system controller (referred to herein as the controller 114) that may be in communication with the analyzers 104, the instruments 106, and other components of the laboratory system 100. In some embodiments, the controller 114 may be a computer that may or may not be located proximate the laboratory system 100. In some embodiments, the controller 114 may be proximate the analyzers 104 and the instruments 106 and in other embodiments, the controller 114 may be remote from the analyzers 104 and the instruments 106. For example, the controller 114 may be remote from the laboratory system 100 and may process data generated by a plurality of different laboratory systems. Thus, the studies described herein may be generated by a controller remote from the laboratory system 100 (and the controller may generate studies based on data generated from a plurality of different laboratory systems). In some embodiments, one or more of the analyzers 104 and/or instruments may include a processor that is similar to the controller 114 and may perform the studies described herein. The controller 114 may include a processor 116 and memory 118, wherein the processor 116 executes programs 120 comprising executable code that may be stored in the memory 118.

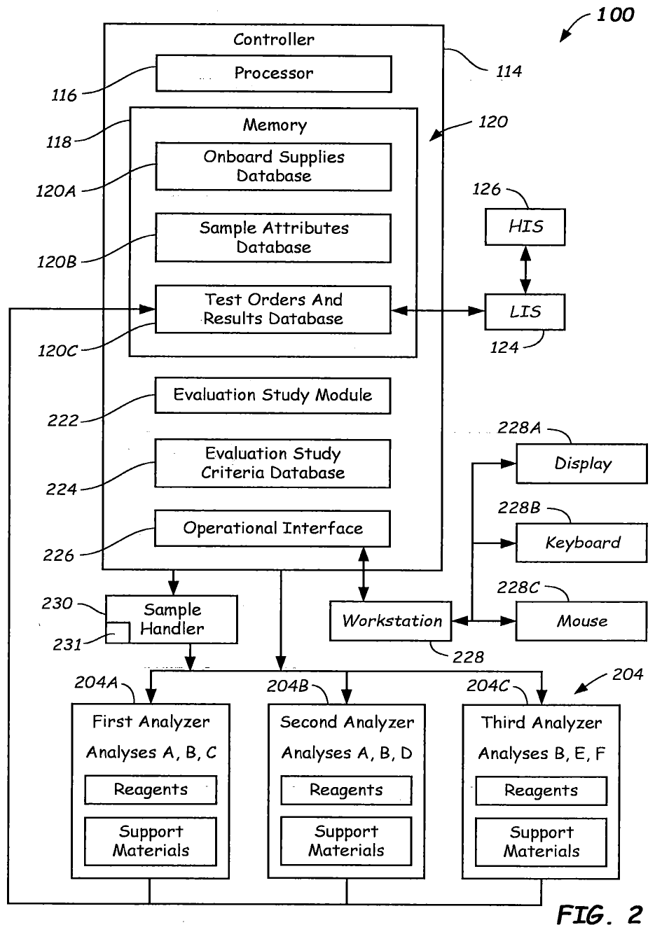

As described above, the processor 116 may be configured to execute programs 120 (e.g., software) stored in the memory 118. In some embodiments, the processor 116 and/or the controller 114 may be configured to perform actions other than executing the programs 120 stored in the memory 118. For example, the processor 116 may be configured to execute programs stored in other devices, such as workstations (e.g., workstation 228—FIG. 2), servers, and the like. In some embodiments, the programs 120 may perform the evaluation studies described herein. In some embodiments, the programs 120 may instruct the instruments 106 and/or the analyzers 104 to perform analyses described herein.

In some embodiments, the programs 120 may enable users of the laboratory system 100 to cause the analyzers 104 to seamlessly transition between performing analyses on patient samples and performing the studies described herein. The studies may cause the analyzers to evaluate test materials, including new reagents, calibrators, quality control materials, and other materials. In some embodiments, the programs 120 may perform the studies while users perform other functions using the laboratory system 100, such as performing assays on patient samples. In some embodiments, the programs 120 enable automatic validations of new test materials introduced into the laboratory system 100 to be put into routine use without the user performing manual steps, repurposing patient orders, or using an offline data analytics program to produce statistics and reports of the new test materials.

In some embodiments, the controller 114 may be electrically coupled to a laboratory information system (LIS) 124, which may be electrically coupled to a hospital information system (HIS) 126. The HIS 126 may receive test orders, such as from doctors and other medical providers, and may electronically transmit the test orders to the LIS 124. Based on the test orders, samples may be taken from patients and sent to the laboratory system 100. In summary, the LIS 124 may coordinate the assays and tests performed on the samples by the laboratory system 100 in response to the test orders and the received samples. In some embodiments, the results generated by the study evaluations are not transmitted to the LIS 124 while the patient samples assay results are transmitted uninterrupted to the LIS 124. In some situations, the study results are not reportable to clinicians and are for internal laboratory use only.

Additional reference is made to FIG. 2, which illustrates a more detailed embodiment of the controller 114 and interactions between the controller 114 and analyzers 204. The analyzers 204 may be identical or substantially similar to one or more of the analyzers 104 (FIG. 1) and/or analyzers within one or more of the instruments 106. The embodiment of FIG. 2 includes three analyzers 204, which are referred to as the first analyzer 204A, the second analyzer 204B, and the third analyzer 204C.

In the embodiment of FIG. 2, the programs 120 stored in the memory 118 may include an onboard supplies database 120A, a sample attributes database 120B, and a test orders and results database 120C. In addition, the controller 114 may include other ones of the programs 120 including an evaluation study module 222, an evaluation study criteria database 224, and an operational interface 226. The controller 114 may include and/or have access to other programs. In some embodiments, the programs 120 may be stored at locations other than the controller 114.

The onboard supplies database 120A may, in some embodiments, include a database that tracks supplies available in one or more of the analyzers 204. For example, in some embodiments, the onboard supplies database 120A may track available test materials, such as reagents, quality control materials, calibrator materials, and hardware, such as probe tips and the like, in one or more of the analyzers 204. The onboard supplies database 120A may track other materials present in one or more of the analyzers 204.

In some embodiments, the sample attributes database 120B may include data related to attributes of samples in or available to one or more of the analyzers 204. The samples may include patient samples that may be used in calibration and/or quality control testing in the analyzers 204. The attributes may include, but are not limited to, sample types, lot numbers, expiration information. In some embodiments, the sample attributes database 120B or the onboard supplies database 120A may include information as to the quantity of samples available to a particular one of the analyzers 204.

In some embodiments, the test orders and results database 120C may receive test orders from the LIS 124. The test orders may, as an example, be orders for assays that are to be performed on samples by the analyzers 204. The controller 114 may transmit instructions to the analyzers 204 that causes the analyzers 204 to perform the assays. In some embodiments, the assay results may be transmitted from the analyzers 204 and stored in the test orders and results database 120C. In some embodiments, the assay results may be transmitted from the controller 114 to, e.g., the HIS 126.

In some embodiments, the controller 114 may include or have access to an evaluation study module 222, an evaluation study criteria database 224, and an operational interface 226. In some embodiments, the evaluation study module 222, the evaluation study criteria database 224, and the operational interface 226 may be implemented in the programs 120 and may be stored in the memory 118. Other modules and/or programs may be available, such as to print, file, and/or format studies. The modules and/or programs may print, file, and/or format the studies to meet specific regulatory requirements, for example.

The evaluation study module 222 may store data pertaining to one or more studies that may be performed by the controller 114. The studies may be directed to evaluating different items and processes associated with the analyzers 204, including analyzing new test materials and/or testing processes of one or more of the analyzers 204.

In some embodiments, the evaluation study module 222 may include instructions for running one or more of the studies. The instructions may cause the controller 114 and/or one or more specific ones of the analyzers 204 to perform the studies described herein. For example, the instructions may cause the analyzers 204 to perform certain mechanical operations that cause the analyzers 204 to perform the studies described herein. One or more programs in the controller 114 or associated with the controller 114 may analyze the studies to ensure that the analyzers 204 are functioning correctly, reduce the probability of analytical errors, and/or demonstrate compliance with various regulations. In some embodiments, one or more of the studies may be performed on a plurality of the analyzers 204. Various embodiments of studies are described in greater detail herein. The evaluation study module 222 and/or other programs may include instructions to run studies other than those described herein.

In some embodiments, the evaluation study criteria database 224 may be implemented with the evaluation study module 222. The evaluation study criteria database 224 may include criteria and/or parameters for the studies that are to be conducted. For example, the evaluation study criteria database 224 may include requirements, such as certain materials required to be used for at least one of the studies. In some embodiments, the evaluation study criteria database 224 may include regulatory requirements associated with one or more of the studies.

The operational interface 226 may provide an interface between a user and the controller 114 and/or one or more of the analyzers 204. In some embodiments, the operational interface 226 may provide an interface to a workstation 228 or the like that enables a user to interact with the controller 114 and/or one or more of the analyzers 204. In some embodiments, the workstation 228 may be directly coupled to one or more of the analyzers 204 and may perform one or more of the functions of the controller 114, such as running one or more studies. In some embodiments, the workstation 228 may be incorporated into the controller 114.

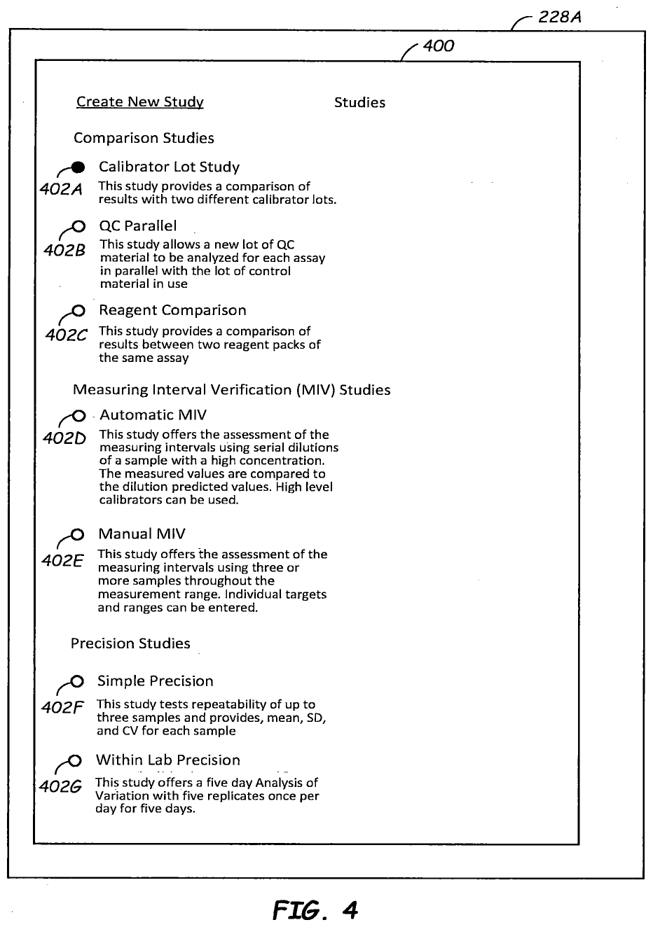

The workstation 228 may be electrically coupled to at least one of a display 228A, a keyboard 228B, and a mouse 228C. The display 228A may enable the user to view the studies described herein and provide a graphical user interface (e.g., GUI 400—see FIG. 4) that enables the user to input data for selecting and/or customizing one or more studies. The keyboard 228B and the mouse 228C may further enable the user to input data regarding one or more studies. The workstation 228 may be electrically coupled to other devices.

In some embodiments, the operational interface 226 enables the user to view one or more of the studies generated by the controller 114 (i.e., programs run by the controller) and/or the workstation 228 on the display 228A. In some embodiments, the operational interface 226 may receive data the user has entered, such as via the workstation 228. The data may include which of one or more studies are to be run. In other embodiments, the data may enable the user to customize one or more studies.

The analyzers 204 may perform different assays on different types of samples. For example, the first analyzer 204A may be configured to run analyses A, B, and C, which may each test for a specific chemical in a sample. The second analyzer 204B may be configured to run analyses A, B, and D. The third analyzer 204C may be configured to run analyses B, E, and F. One or more of the analyzers 204 may include one or more test materials as described with reference to the onboard supplies database 120A that enable the analyzers to perform the specific analyses. Thus, the amount and/or types of test materials present in one or more of the analyzers 204 may be communicated to the controller 114 and stored in the onboard supplies database 120A, for example.

The controller 114 may generate instructions to operate a sample handler 230. The sample handler 230, in some embodiments, may be a group of devices that move samples and/or sample containers 102 (FIG. 1) throughout the laboratory system 100. Accordingly, the sample handler 230 may cause samples and/or test materials to be moved to specific ones of the analyzers 204 by way of the track 110 (FIG. 1). In some embodiments, the sample handler 230 may include a storage module 231 that can store calibrators, quality control materials, and/or other materials used by one or more of the analyzers 204. In some embodiments, the storage module 231 may be a refrigerated storage module. The stored (refrigerated) materials can be selected directly from the storage module 231 and transferred to specific ones of the analyzers 204 by the track 110 (FIG. 1) for use in precision studies, QC lot parallel studies, calibration lot studies, or other studies.

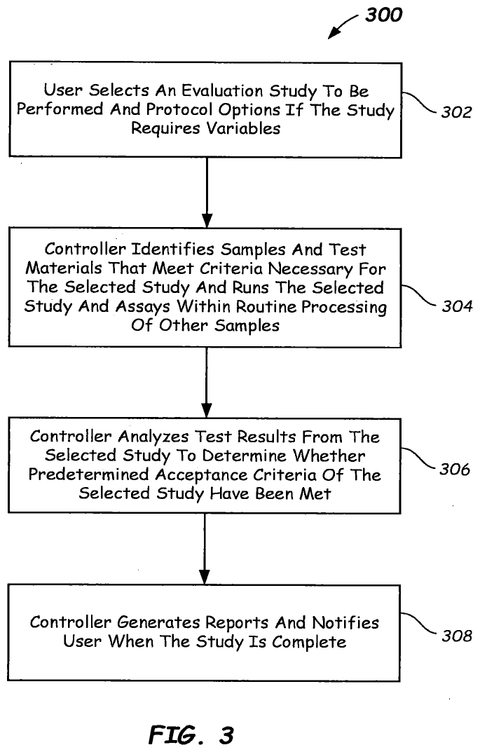

Additional reference is made to FIG. 3, which is a flowchart illustrating a method 300 of using the controller 114 in the laboratory system 100 (FIG. 1) to generate one or more studies. The studies may be performed using one or more of the analyzers 204. The method 300, in block 302, includes a user selecting an evaluation study to be performed and protocol options if the selected study requires variables. As shown in FIG. 4, the studies may include, but are not limited to comparisons studies, measuring interval verification (MIV) studies, and precision studies. Other studies may be selected.

The comparison studies may include comparisons of different test materials. Examples of the test materials include, but are not limited to calibrator materials, reagents, and quality control (QC) materials. Studies within the comparison studies, include, but are not limited to calibrator lot studies, QC parallel studies, and reagent comparison studies. Other studies may be performed.

The calibrator lot studies provide at least one comparison of results of two different calibrator lot analyses, wherein the calibrator lots are test materials. If the calibrators from the different lots are adequate for testing, the results of the analyses should be within a predetermined range relative to one another and may be defined by a specific standard operating procedure (SOP). The QC parallel studies may provide for a new lot of QC material to be analyzed for each assay in parallel with the lot of control material in use, wherein the QC material is the test material. The reagent comparison studies provide a comparison of test results between two reagent packs of the same assay, wherein the reagents and/or the reagent packs are the test materials. If the reagents are proper for use in the analyzer, the results of tests of the two reagent packs should be within a predetermined range of each other. These studies enable the user and/or the controller 114 to determine the differences between the reagent packs. In some situations, a difference is expected, such as when raw materials are changed. These studies can be used in different ways to determine the root cause of differences, such as analyzer hardware, reagent preparation, etc. The laboratory system 100, user, and/or controller 114 may make a decision about whether the new reagent may be used after evaluating the study results.

The measuring interval verification (MIV) studies may include at least one automatic measuring interval verification study and/or at least one manual MIV study, wherein chemicals added to the samples are the test materials. The automatic MIV study may provide studies based on assessments of the measuring intervals using serial dilutions of a sample with a high concentration. In some embodiments, the MIV studies support one or more regulations or common laboratory SOPs to test the performance periodically throughout a specific range of the assay, for example. The measured values may be compared to dilution predicted values by plotting values on a graph, for example. In some embodiments, high level calibrators may be used. In some embodiments, the manual MIV provides an assessment of the measuring intervals using three or more samples throughout a measurement range. In some embodiments, individual targets and ranges may be entered into the controller 114 via the workstation 228, for example. The MIV studies may provide other studies.

The precision studies may provide simple precision studies and/or studies within laboratory precision studies wherein, again, chemicals added to the samples are the test materials. The precision studies may test repeatability of up to a predetermined number of samples (e.g., three samples) and may provide mean, standard deviation, and/or a coefficient of variation (CV) for each sample. The studies within laboratory precision may provide analyses of variations with a predetermined number of replicates for a predetermined period. In some embodiments, the study provides analyses of variation over five days with five replicates once per day for five days. In some embodiments, the study utilizes samples stored in the analyzer, such as in the storage module 231 (FIG. 2) of the sample handler 230. The precision studies may provide other studies.

In block 304, the controller 114 (via the sample attributes database 120B and/or the evaluation study criteria database 224) may identify samples and test materials that meet criteria necessary for the selected study. The evaluation study module 222 may run the selected study while the controller 114 and/or the analyzers run assays within routine processing of other samples. Thus, the analyzers 204 may run both the selected study and assays on other samples.

In block 306, the controller 114 analyzes test results from the selected study to determine whether predetermined acceptance criteria of the selected study have been met. For example, the evaluation study criteria database 224 may compare test results from the study to predetermined values to determine whether a test material is appropriate for use in the analyzers 204.

In block 308, the controller 114 may generate one or more reports and may notify the user when the study is complete.

The aforementioned studies implemented on the analyzers 204 (FIG. 2) are described in detail below. Reference is made to FIG. 4, which illustrates a graphical user interface (GUI) 400 that may be displayed on the display 228A, wherein the GUI 400 is requesting input from a user regarding a study to be performed per block 302 (FIG. 3) of the method 300 on at least one of the analyzers 204. Other embodiments of the GUI 400 may be displayed. The controller 114 (FIG. 2) and/or the workstation 228 may cause the display 228A to display the GUI 400, other GUIs described herein, and other information described herein as being displayed on the display 228A. As described herein, the studies may be performed simultaneously with assays being performed by the analyzers 204.

As shown in FIG. 4, a user has selected a calibrator lot study under the comparison studies as noted by the bubble 402A. Other bubbles may be selected to select other studies as described herein. Portions of the GUI 400 may provide summaries of the studies. As shown in FIG. 4, the calibrator lot study may provide a comparison of test results using two different calibrator lots. In some embodiments, the calibrator lot study may be at least partially based on the protocol described in the clinical and laboratory standards institute (CLSI) guideline EP-09 titled: Method Comparison and Bias Estimation Using Patient Samples. The calibrator lot study may be based on other protocols. At least one objective of the calibrator lot study may be to restrict variables (e.g., reagents, analyzers, and/or samples) enough that the laboratory system 100 (e.g., the controller 114) can determine what effect the calibrator lot itself will have on assay results of patient samples. The same analyzer, reagent, and samples may then be used for performing assays after calibration of the lots. The difference in the results can be attributed to the calibrator alone.

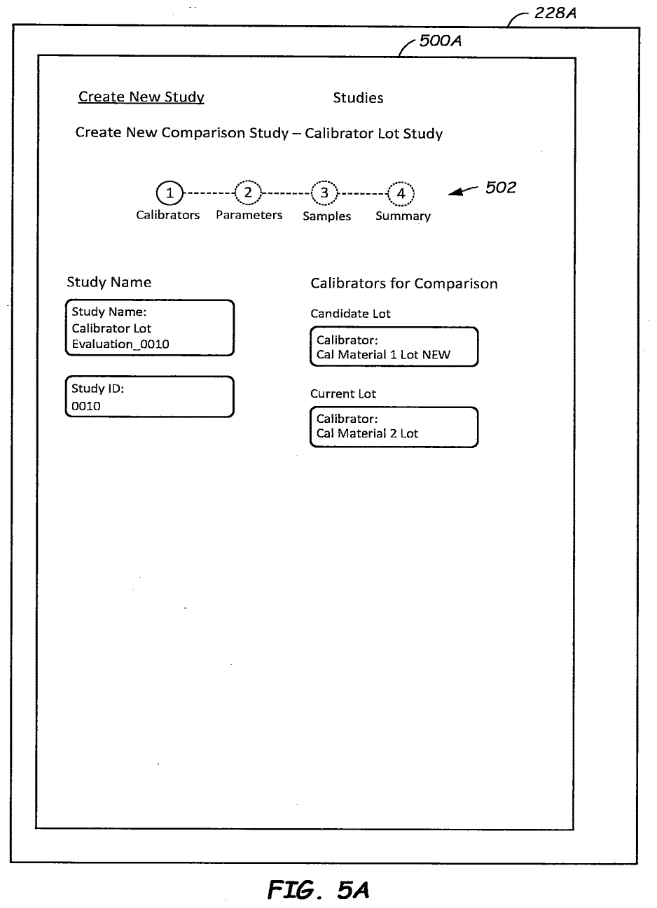

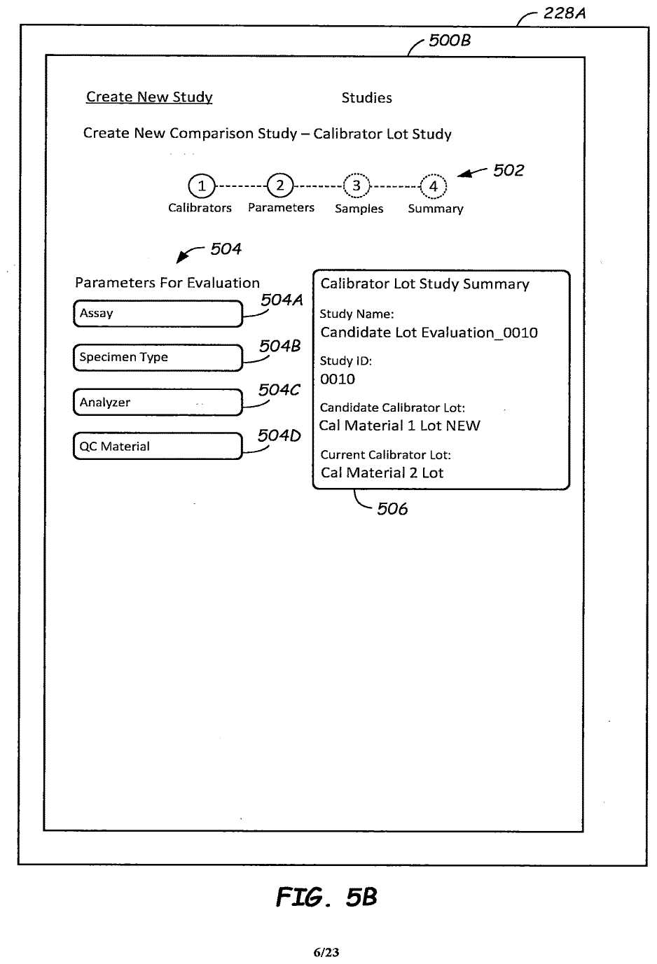

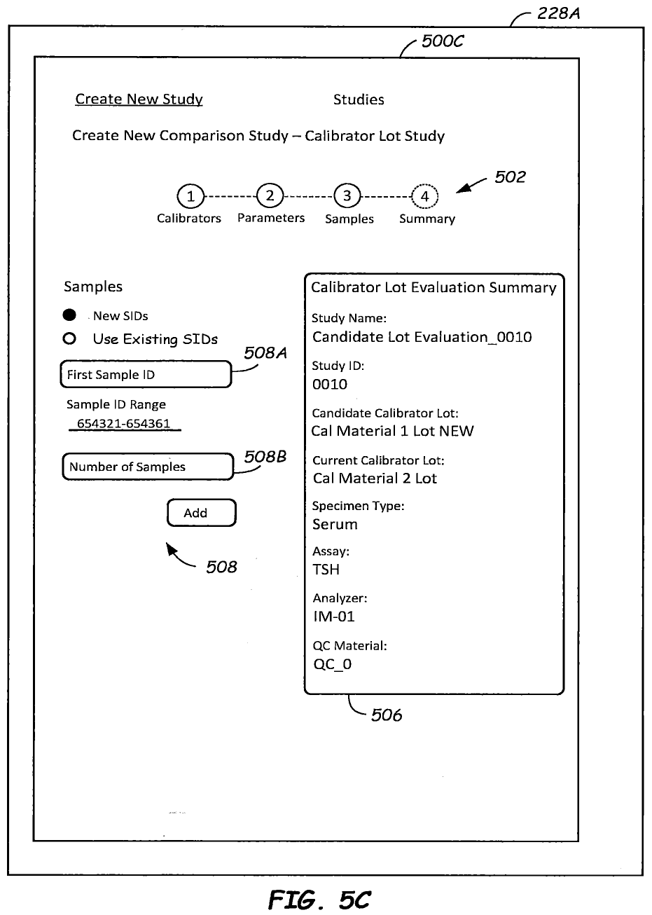

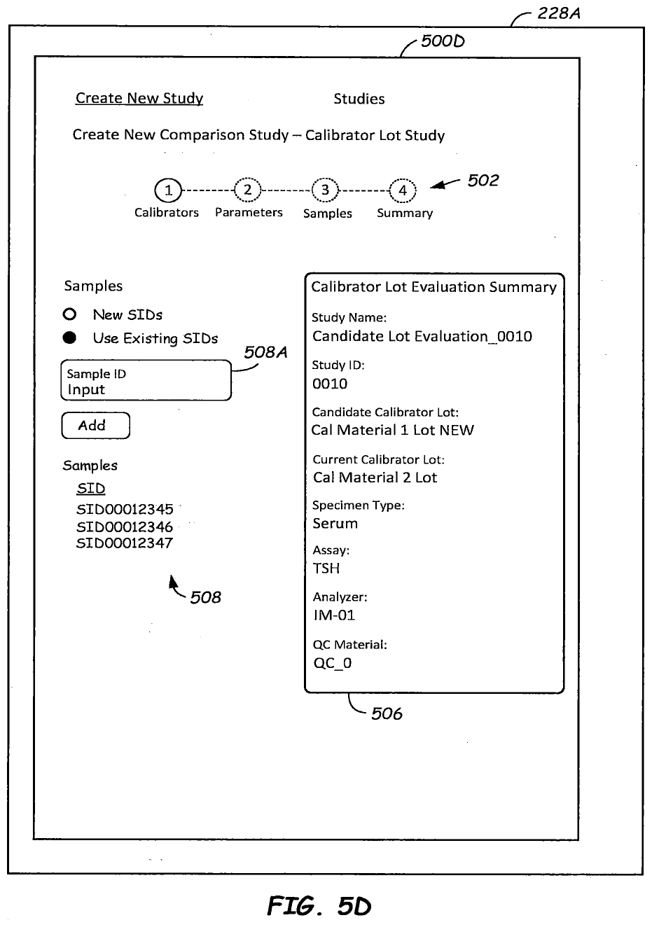

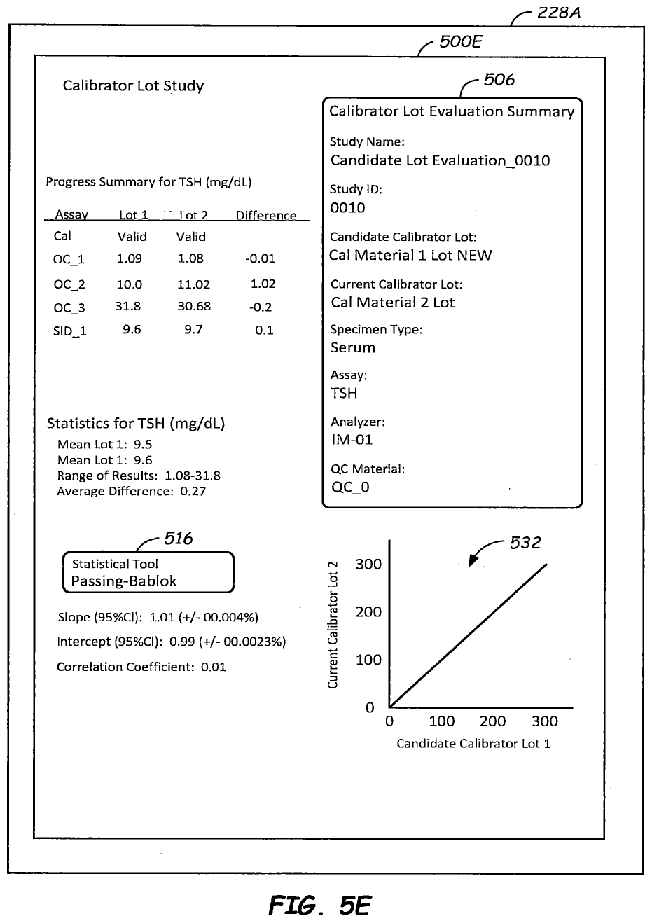

After the calibrator lot study has been selected, the display 228A may display another GUI as described herein to customize the calibrator lot study. FIG. 5A illustrates an embodiment of a GUI 500A that may be displayed on the display 228A after selection of the calibrator lot study in FIG. 4. The GUI 500A enables a user to input preliminary information regarding the calibrator lot study, such as per the block 302 in FIG. 3. The following embodiments of GUIs provide examples of processes used by the controller 114 (FIG. 2) and/or the workstation 228 that may cause one or more of the analyzers 204 (FIG. 2) to perform the calibrator lot study. The GUI 500A may include a progress indicator 502 configured to indicate the progress of setting up and running the calibrator lot study. Other progress indicators may be displayed.

The GUI 500A may enable a user to enter information including a study name and a study identification. In the embodiment of FIG. 5A, the study name is “calibrator lot evaluation_0010” and the study ID is 0010. The Study ID may provide traceability and searching of a database. The traceability and searching may return all samples that were involved in that study. Therefore, the user does not have to search for samples individually in the database. In addition, the GUI 500A may enable the user to enter the calibrators for comparison in the calibrator lot study, which may be the test materials. In the embodiment of FIG. 5A, the user may select a candidate lot, which in the embodiment of FIG. 5A is referred to as “cal material lot 1” and is a new calibration material lot. The user may also select a current calibration material lot, which in the embodiment of FIG. 5A is referred to as “cal material lot 2”. The items associated with the study name and the calibrators for comparison may be accessed by way of pulldown menus. Thus, the onboard supplies database 120A (FIG. 2) may track available calibrator lots and the controller 114 and/or the workstation 228 may cause the available calibrator lots to be displayed on the GUI 500A.

After the user has entered the information in FIG. 5A, the GUI 500A may be replaced or changed to a different GUI that requests further information. For example, FIG. 5B illustrates a GUI 500B configured to receive parameters for running the calibrator lot study. The GUI 500B may display one or more parameters for evaluation 504. One or more of the parameters for evaluation 504 may be configured as one or more pulldown menus. In the embodiment of FIG. 5B, the parameters for evaluation 504 may include an assay menu 504A, a specimen type menu 504B, an analyzer menu 504C, and a QC material menu 504D.

The assay menu 504A may include the enabled assays supported by the candidate calibrator lot and the current calibrator lot. In some embodiments, the calibrator lot study may only be run if a selected assay is supported by both the candidate calibrator lot and the current calibrator lot. In some embodiments, the evaluation study module 222 (FIG. 2) may determine if the selected assay is supported by both the candidate calibrator lot and the current calibrator lot. The specimen type menu 504B may include the specimen types supported by the assay selected from the assay menu 504A. In some embodiments, the evaluation study module 222 (FIG. 2) may provide the specimen types in the specimen type menu 504B in response to the assay selected from the assay menu 504A.

The analyzer menu 504C may include one or more of the analyzers 204 (FIG. 2) that support the assays included in the candidate calibrator lot and the current calibrator lot. In some embodiments, the evaluation study module 222 (FIG. 2) may provide the analyzers that are displayed in the analyzer menu 504C. The QC material menu 504D may include only the QC materials that support the selected assay and specimen type. In some embodiments, the evaluation study module 222 (FIG. 2) may provide the QC materials that are displayed in the QC material menu 504D.

In some embodiments, when only a single item in one of the menu items in the parameters for evaluation 504 is available, the GUI 500B may not enable other items to be selected. For example, if only one of the analyzers 204 (FIG. 2) is configured to perform the calibrator lot study, then the analyzer menu 504C may display only that analyzer and not enable the user to select other analyzers. The same may apply to other items in the menus of the parameters for evaluation 504 and menus in other GUIS.

The GUI 500B may include a summary window 506 that provides information to the user regarding the status of the calibrator lot study. In some embodiments, the summary window 506 may display items selected in previous GUIs. Other information may be displayed. Other GUIs in the calibrator lot study and other studies may display similar summary windows.

After the items in the GUI 500B are entered, the workstation 228 (FIG. 2) and/or the controller 114 may cause a GUI 500C to be displayed on the display 228A as illustrated in FIG. 5C. The GUI 500C enables the user to select which samples are to be used for the calibrator lot study. In some embodiments, the GUI 500C may enable the user to enter new sample identifications (SIDs) or existing SIDs by selecting the appropriate bubble. In the embodiment of FIG. 5C, the “New SIDs” bubble is selected. The GUI 500C may also include a sample input 508 that enables the user to enter the samples to be studied in the calibrator lot study. The sample input 508 may include a sample ID menu 508A that enables the user to enter and/or select a first SID. In some embodiments, a user may enter a sample ID range as shown in FIG. 5C. The sample input 508 may also include a sample number menu 508B that enables the user to enter the number of samples. In some embodiments, the sample number menu 508B may provide a predetermined range of samples.

When “New SIDs” is selected as shown in FIG. 5C, the user can setup the parameters for setting up a range of SIDs for the batch to be used in the calibrator lot study. The user may enter a first SID (e.g., a start SID) and a number of samples that are to be used. In some embodiments, when selecting the first SID, a user can either type the first SID in manually or the user can scan in the SID via other means, such as a barcode scanner, for example. After the start SID and the number of samples have been entered, the Add button on the GUI 500C may change appearance. The add button may then be activated by a user to enable the user to enter another SID.

The summary window 506 may be updated to reflect changes made by use of the previous GUI. For example, the summary window 506 may show the specimen type, assay, analyzer, and QC material that were previously selected. The summary window shown in FIG. 5C is an example summary window. Other summary windows may be displayed.

If, in FIG. 5C, the user selected “Use existing SIDs,” the GUI 500D of FIG. 5D may be displayed on the display 228A. The user may, in some embodiments, scan or manually enter the SIDs individually. In some embodiments, each SID may be displayed after each SID is entered. In some embodiments, the workstation 228 (FIG. 2) and/or the controller 114 may enable the user to print barcodes that may be affixed to the containers that hold the entered samples. In some embodiments, the summary window 506 may be updated to reflect the entered SIDs.

When all the information is entered to the controller 114 (FIG. 2), the user may instruct the controller 114 to perform the calibrator lot study per block 304 (FIG. 3) of the method 300. In some embodiments, the calibrator lot study may be performed while the analyzer on which the study is being performed is performing assays on samples. Thus, running the study may not affect normal testing on the selected analyzer or the impact may be minimal. In some embodiments, the user may cause the calibrator lot study to be performed immediately, which may cause the selected analyzer to prioritize the study and delay performing assays while the study is being performed.

Referring to FIG. 2, the controller 114 and/or the workstation 228 may generate instructions to run the study based on the inputs from the user. The instructions, when executed, may cause the laboratory system 100 to obtain one or more test materials (e.g., calibrator lots) in response to the calibrator lot study being selected. The study may perform an analysis using the one or more test materials in response to the selected study, wherein the analysis may identify differences between the selected calibrator lots.

Additional reference is made to FIG. 5E, which illustrates an example of study results 500E showing information related to the completed calibrator lot study. As shown in FIG. 5E, the study may include a progress summary for the calibrator lot study using the TSH assay. The study results 500E may include assay results for the individual lots and the differences between the assay results, which is the comparison between the lots. The study results 500E may also include the mean of assay results of both lots, the range of the assay results, and the average difference between the assay results. The study results 500E may include a statistical tool menu 516 that enables a user to select a statistical tool to compare the results. Additional statistical tools may be offered for the calibration lot evaluation and comparison evaluations, such as linear regression, Deming regression, and weighted Deming regression. The study results 500E may also include a graph 532 showing results of the current calibrator lot and the candidate calibrator lot plotted against one another. Under ideal conditions, the graph 532 should have a slope of one. Analysis of the graph 532 including the slope, intercept, and correlation coefficient may also be displayed. Other analysis of the results may be displayed as shown in the study results 500E.

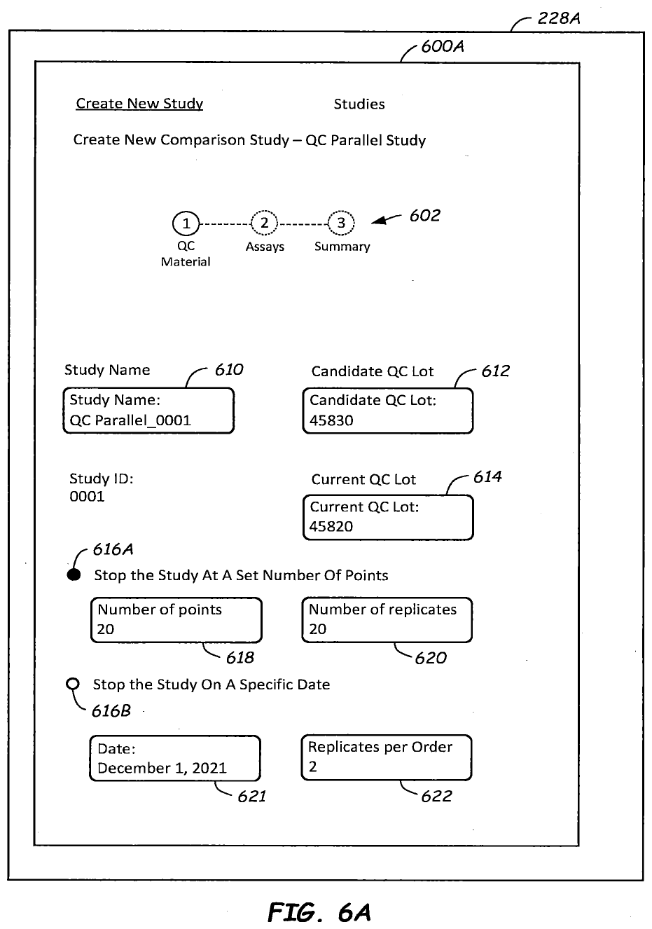

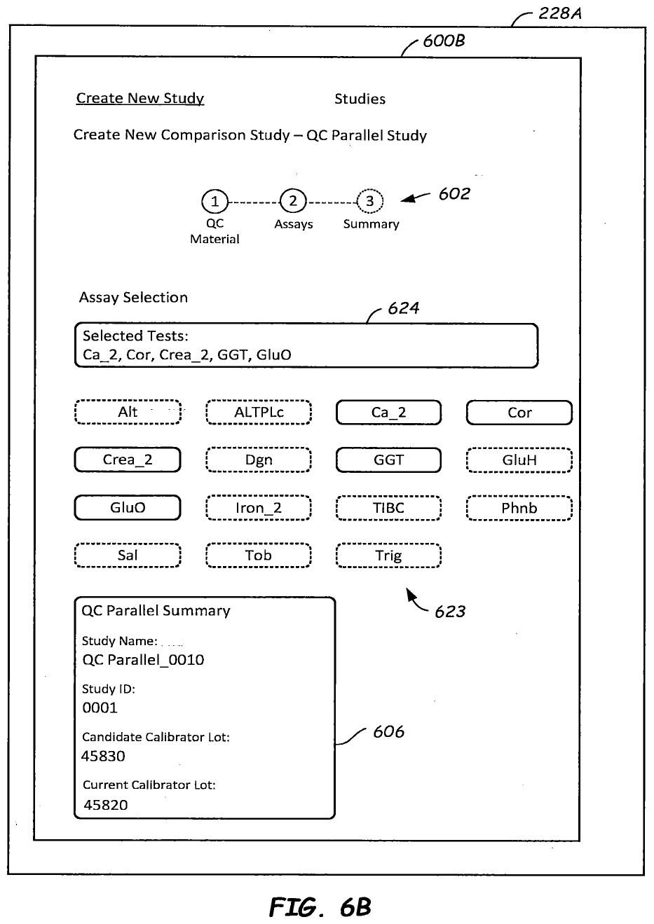

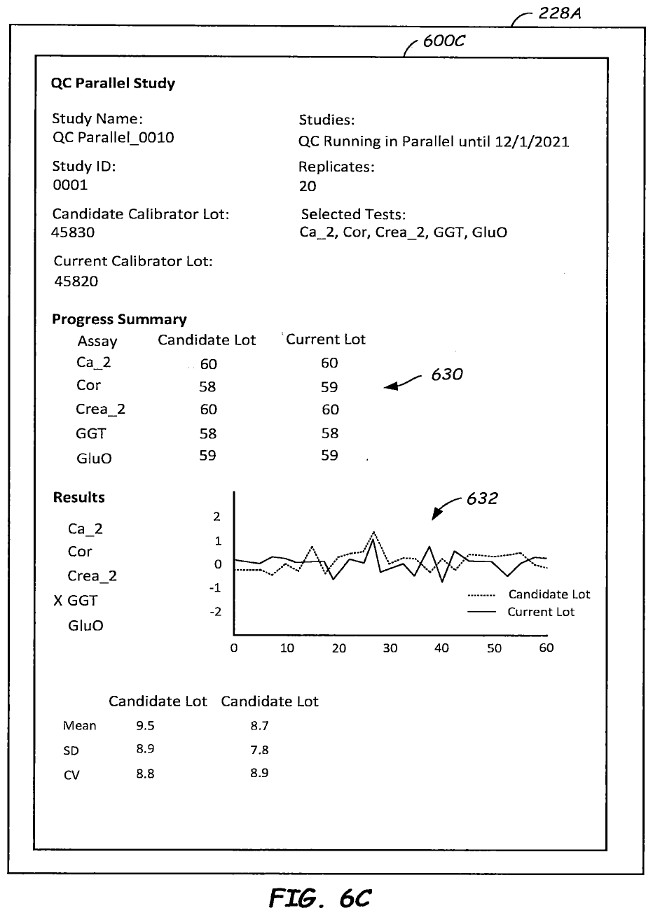

Referring again to FIG. 4, the user may select to run the quality control parallel study by selecting the QC parallel bubble 402B. The objective of a QC lot crossover or parallel study may be to establish or verify the assigned targets and ranges for a new QC material by comparing the new QC material in real time to the current QC material. In some embodiments, the QC parallel study may evaluate a plurality (e.g., 20) points of data across as many days as possible in tandem with the current QC lot, which may run the tests in parallel, so the QC materials are tested in as similar conditions as possible. The study may be based on the protocol described in CLSI C24-ED4 titled Statistical Quality Control for Quantitative Measurement Procedures. After the QC parallel study has been selected, the workstation 228 (FIG. 2) and/or the controller 114 may cause the display 228A to display GUIs as described herein to enable the user to enter data to run the QC parallel study. Reference is made to FIG. 6A, which illustrates a GUI 600A that may be displayed on the display 228A per commands generated by the workstation 228 (FIG. 2) to generate a QC parallel study.

The GUI 600A may include a progress indicator 602 that shows the progress of the QC parallel study. The progress indicator 602 may be substantially similar to the progress indicator 502 (FIG. 5A). The GUI 600A may display a study name menu 610, which may be displayed as a pulldown menu. The study name menu 610 may enable a user to enter the study name manually, such as by the user. The GUI 600A may also display the candidate QC lot menu 612, which may be a menu (e.g., a pulldown menu) that enables the user to select the candidate QC lot that the user wants to be evaluated. In some embodiments, the onboard supplies database 120A (FIG. 2) and/or the evaluation study module 222 (FIG. 2) or another module or database may store the candidate QC lots displayed on the QC lot menu 612. In some embodiments, the storage module 231 (FIG. 2) may refrigerate and store the QC material throughout the extent of the study (possibly days) and may automatically handle the deployment of both the current and candidate QC materials at prescribed times.

The GUI 600A may also display the current QC lot menu 614, which is a menu that enables the user to select the current QC lot. In some embodiments, the QC lot menu 614 may enable the user to manually enter the current QC lot. The current QC lot is the lot the user wants to use for a comparison and that may be present in the analyzer. The current QC lot menu 614 may list the active QC materials in use on the analyzer that support at least one assay as with the QC candidate lot. In some embodiments, the onboard supplies database 120A (FIG. 2) and/or the evaluation study module 222 (FIG. 2), or another module or database, may store the current QC lots from which the current QC lot may be selected.

The GUI 600A may display a bubble 616A that, when selected, causes the controller 114 to run the study comparing the selected QC lot for a specified number of points (e.g., data points). The GUI 600A may display a dropdown menu 618 that may enable the user to select the number of points. In addition, the GUI 600A may display a pulldown menu 620 that may enable a user to select the number of replicates used in the study. In some embodiments, the pulldown menu 620 may be a number of matching orders. The GUI 600A may display a bubble 616B that, when selected, causes the controller 114 to run the study comparing the selected QC lot through a specific date. The GUI 600A may display a date menu 621 that enables the user to select the date. In addition, the GUI 600A may display a menu 622 that enables the user to select the number of replicates per order. Once the date advances beyond the specified date in the date menu 621, the controller 114 may automatically stop the study.

Irrespective of the stopping criteria selected by the bubble 616A or the bubble 616B, the workstation 228 may display a GUI 600B that enables the user to enter assays as illustrated in FIG. 6B. The GUI 600B may enable a user to select assays that have been defined in both the candidate QC lot and the current QC lot. In the embodiment of FIG. 6B, the GUI 600B may include an assay array 623 having a plurality of selectable bubbles, wherein each of the bubbles contains an assay. The user may select assays by selecting the corresponding bubbles in the assay array 623. In the embodiment of FIG. 6B, the assays Ca_2, Cor, Crea_2, GGT, GluO have been selected. Selected assays may be indicated by different bubble formats, such as solid bubbles versus dashed bubbles. In some embodiments, a user may select all assays by selecting a specific bubble (not shown). A display area 624 may display the selected assays. In some embodiments, the GUI 600B may include a summary window 606 that may be similar to the summary window 506 (FIG. 5B).

When the assays are selected by way of the assay array 623, the display 228A may display a summary page (not shown) showing the parameters selected for the QC parallel study. In some embodiments, the display 228A may display a GUI (not shown) that enables the user to print barcodes that may be attached to the current lot and/or the candidate lot. The GUI may also enable the user to display the status of the QC parallel study.

When the study is complete, the study results 600C of the parallel QC study may be displayed on the display 228A as shown in FIG. 6C. The embodiment of FIG. 6C depicts the layout of a display displaying the QC parallel study when the study is complete. The study of FIG. 6C was configured to automatically stop at a predetermined date. For example, the bubble 616B (FIG. 6A) may have been selected. A similar study may be configured to automatically stop the study after a predetermined number of points (e.g., measurement tests). For example, the bubble 616A (FIG. 6A) may have been selected.

The study of FIG. 6C may include a progress study 630 that may display assays, candidate lots, and current lots. The display of FIG. 6C may display the results of the QC parallel study, which may include a graph 632. The graph 632 shows the points collected for the selected assay and the corresponding statistics may also be displayed. In the embodiment of FIG. 6C, the results using the candidate lot and the current lot are plotted together on the graph 632. The QC test results for both the current QC lot and the candidate QC lot may be populated to a system QC program for further analysis and tracking.

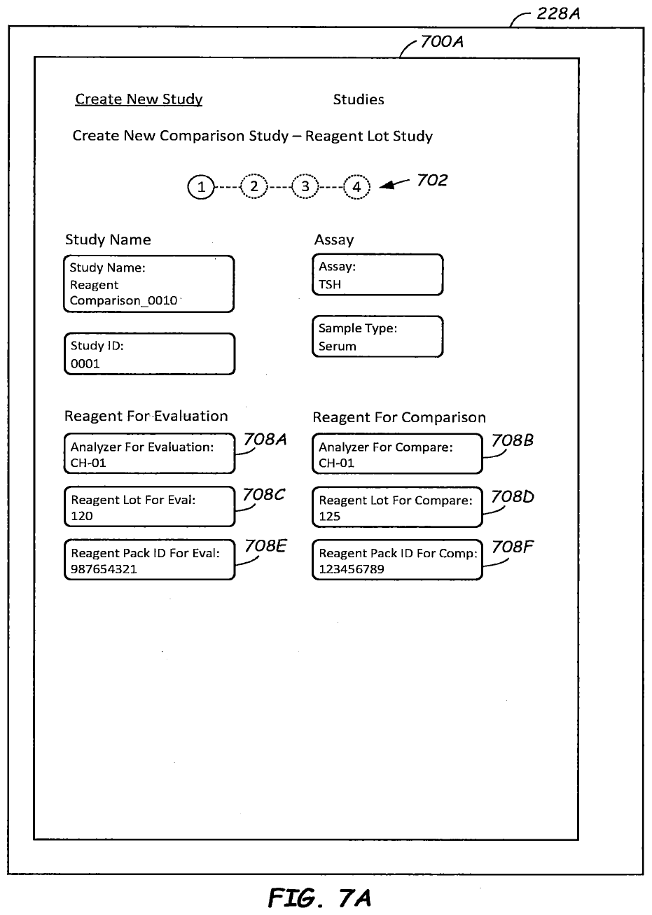

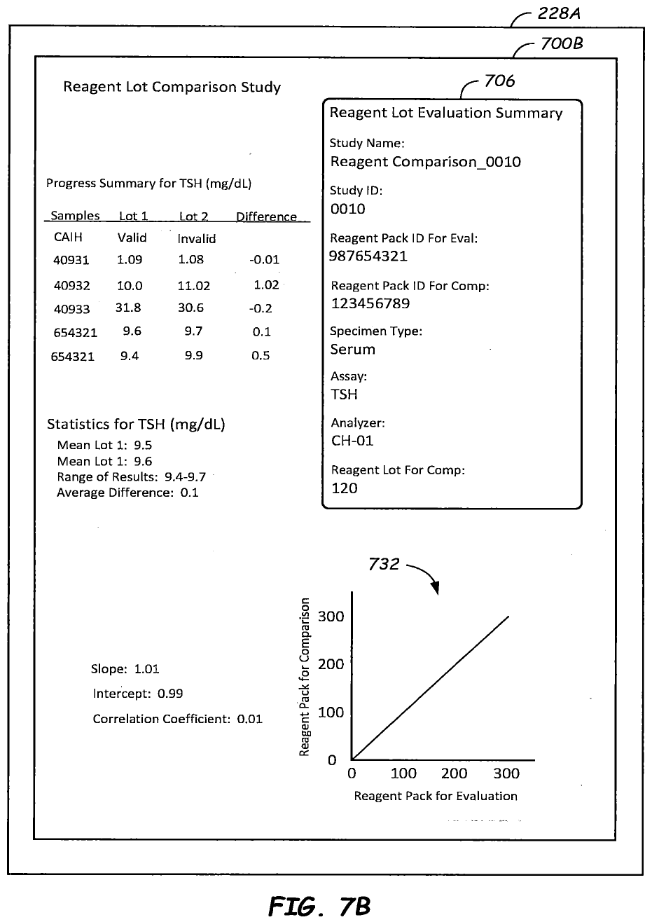

Referring again to FIG. 4, the user may select the bubble 402C to perform a reagent lot comparison study, which is a study that provides a comparison of results between two reagent packs of the same assay. In some embodiments, the reagent study lot may provide differences between two or more reagent lots. In some embodiments, the study is based on the protocol described in CLSI EP-09 titled Method Comparison and Bias Estimation Using Patient Samples. Referring to FIG. 7A, the display 228A may then display a GUI 700A that enables the user to enter information to perform the reagent lot study (e.g., a reagent comparison study). The GUI 700A may include a progress indicator 702 that indicates the process of the reagent lot study.

As shown in FIG. 7A, the GUI 700A may enable a user to enter information (e.g., parameters of the study), which in some embodiments may be entered by pulldown menus. The information may include a study name, a type of assay, a study ID, and sample type configured for the selected assay. In the embodiment of FIG. 7A, the assay is TSH, and the sample type is serum. The information entered by the user may enable the user to structure the study in a particular format.

The user may then select reagent fields, which include a reagent for evaluation and a reagent for comparison, wherein the reagents may be the test materials. In some embodiments, before the user selects the reagents, the user may select one or more analyzers to perform tests for the comparison. In some embodiments, a pulldown menu 708A and a pulldown menu 708B may provide lists of available analyzers based on the selected assay. Once the analyzer(s) is selected, a first reagent lot menu 708C and a second reagent lot menu 708D may become enabled and may be filled with the reagent lots and reagent packs applicable to the selected analyzer. The first reagent lot menu 708C may list reagent lots for evaluation and the second reagent lot menu 708D may list reagent lots for comparison. The GUI 700A may display a first reagent pack ID menu 708E and a second reagent pack ID menu 708F. The first reagent pack ID menu 708E may be a pulldown menu showing reagent pack IDs that may be used for the study evaluation. The second reagent pack ID menu 708F may be a pull-down menu showing reagent pack IDs that may be used for the comparison.

When the reagent lots have been selected, the workstation 228 (FIG. 2) may cause the display 228A to display another GUI. In some embodiments, the workstation 228 may cause the display 228A to display a GUI requesting the user to select a calibrator lot and QC material similar to the GUI 500A (FIG. 5A) and the GUI 500B (FIG. 5B). In some embodiments, the QC material is a test material. In some embodiments, the user is not prompted to enter the calibrator lot and the QC material. The workstation 228 may cause the display 228A to display a GUI prompting the user to select whether new SIDs or existing SIDs will be used during the study. The GUI may be substantially similar to the GUI 500D (FIG. 5D). A summary window that is similar to the summary window 506 (FIG. 5D) may also be displayed.

When the user has entered the above-described parameters, the controller 114 may transmit instructions to the selected analyzer(s), wherein the instructions cause the selected analyzer(s) and/or the controller 114 (FIG. 2) to generate the reagent comparison study. Reference is made to FIG. 7B, which is an embodiment of study results 700B of the reagent lot evaluation study displayed on the display 228A. The study results 700B illustrated in FIG. 7B may include information similar to information included in the study of FIG. 5E. The study results 700B may include the lot numbers and/or reagent pack identifiers of the reagents on which the sample IDs were tested and the differences between the test results. In addition, the study results 700B may include statistics for the selected assay results. A graph 732 may illustrate the differences between the reagent pack results. The study may also analyze the graph showing the slope of the graph, the intercept, and the correlation coefficient. In some embodiments, the total number of tests may be displayed. Other information may be displayed in the study results 700B.

In some embodiments, the controller 114 (FIG. 2) may collect and/or store sample IDs that meet specific criteria (a range of result concentrations, for example) for the reagent comparison study. When setting the parameters for the study, the user may select sample IDs suggested from a captured list generated by the controller 114. This selection process may be an alternative to selecting new sample IDs

Referring again to FIG. 4, the user may select the bubble 402D in the GUI 400 to perform the automatic measuring interval verification (MIV) study, which may provide an assessment of the measuring intervals using serial dilutions of a sample with a high concentration of a specific analyte. The objective of the automatic MIV study may include making an assessment of the linearity of the assay using serial dilutions. The measured values may be compared to predicted values based on dilution factors. High level calibrators can be used. The study may be based on CLSI EP-06 titled, Evaluation of the Linearity of Quantitative Measurement Procedures.

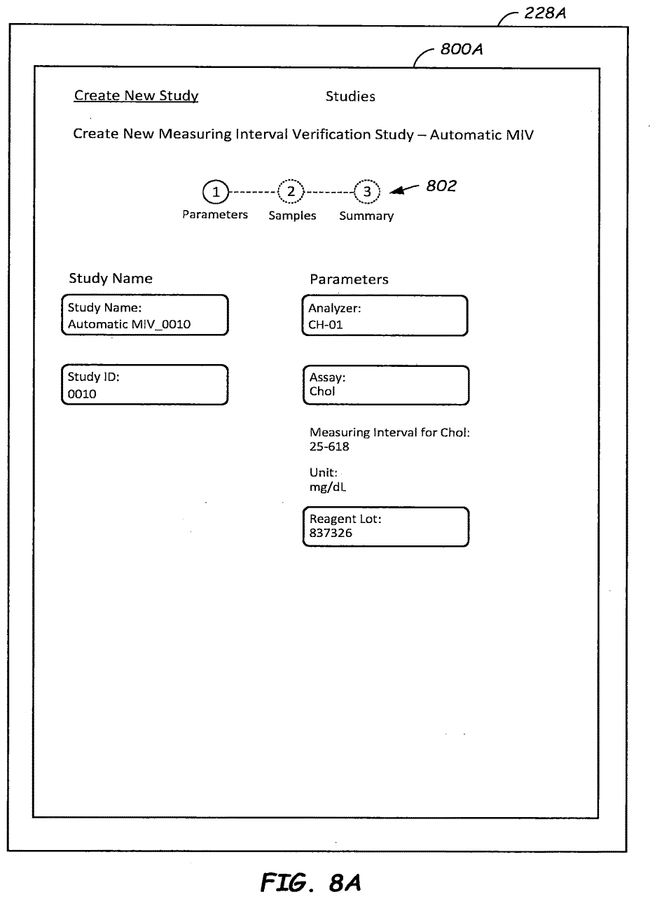

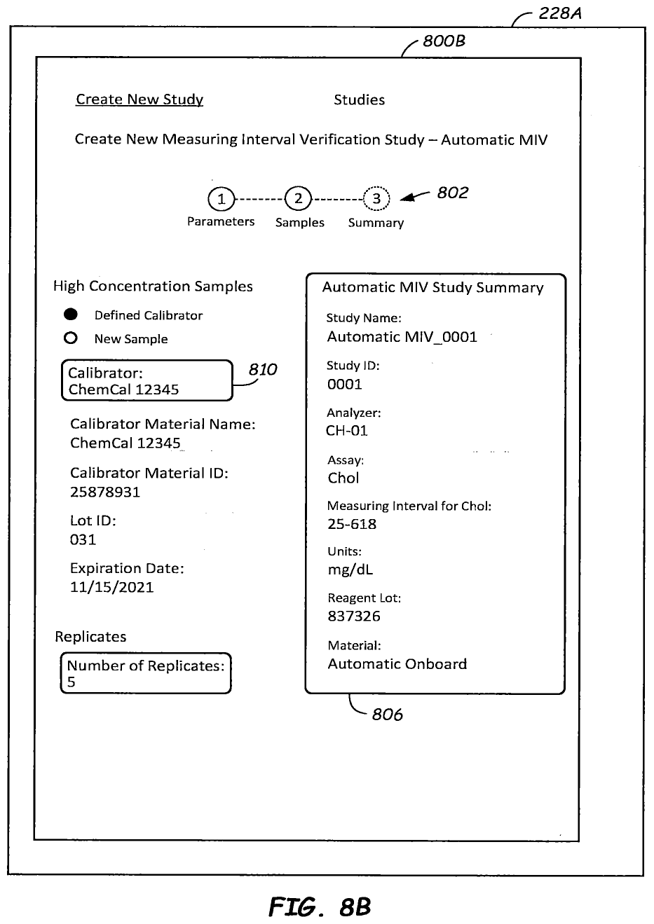

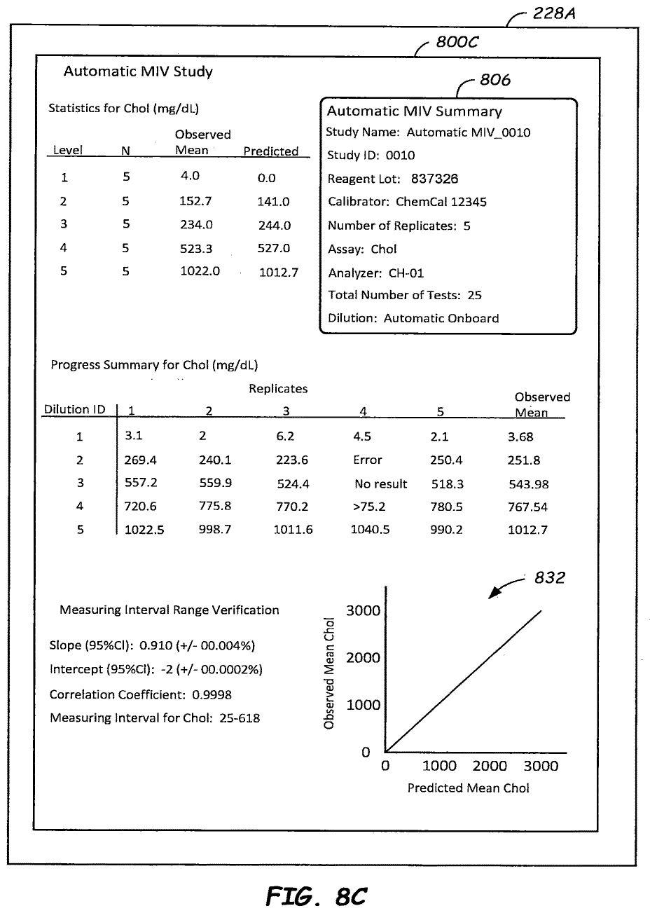

Referring to FIG. 8A, the display 228A may then display a GUI 800A that may enable the user to enter information to perform the automatic MIV study. For example, the controller 114 (FIG. 4) may, based at least in part on input received from the user, generate instructions to at least one selected analyzer that cause the at least one analyzer to run the MIV study. As shown in FIG. 8A, the GUI 800A may enable a user to enter information, which in some embodiments may be entered by pulldown menus displayed in the GUI 800A. In some embodiments, the GUI 800A may include a progress indicator 802 configured to indicate the progress in running the automatic MIV study. Other progress indicators may be displayed.

The GUI 800A may enable the user to input the study name of the automatic MIV study and parameters for running the study. In some embodiments, one or more of the parameters and/or study name may be entered via pulldown menus. The study name and study ID may be entered as described above. In the parameters portion of the GUI 800A, the user may enter the analyzer that is to be used during the automatic MIV study. The analyzer may be selected via a pull-down menu. In the embodiment of FIG. 8A, the analyzer referred to as CH-01 has been selected. When the analyzer is selected, an assay pulldown menu may be displayed that displays the assays enabled on the selected analyzer. In some embodiments, the user may manually enter the assay.

After the assay is selected, the GUI 800A may be updated to show the measuring interval and units for the assay as shown in FIG. 8A. When the analyzer and assay are selected, a reagent lot pulldown menu may become enabled and may be filled with the lots of the selected assay onboard the selected analyzer. In some embodiments, the controller 114 (FIG. 2) may determine the available reagent lots by accessing the onboard supplies database 120A.

After the sample information is entered into the controller 114 via the GUI 800A, the workstation 228 may cause the display 228A to display a GUI 800B as illustrated in FIG. 8B, which enables a user to select the samples to use and the number of replicates used during the automatic MIV study. The GUI 800B may also enable the user to enter high concentration samples. For example, the calibrator may be selected from a pulldown menu 810, for example. In some embodiments, the pulldown menu 810 may show all active calibrator materials that support the selected assay. The GUI 800B may include a summary window 806 that is identical or similar to the previously described summary windows.

When the calibrator is selected, the GUI 800B may display other information, such as the calibrator material name, the calibrator material ID, the lot ID, and the expiration date. This information may be retrieved from the sample attributes database 120B (FIG. 2) and/or the onboard supplies database 120A, for example. When the information is entered into the controller 114 (FIG. 2), the controller 114 may generate instructions that cause the selected analyzer to run the automatic MIV study per the criteria selected.

Reference is made to FIG. 8C, which illustrates the display 228A displaying an embodiment of the study results 800C of the automatic MIV study. The study results 800C may include statistics for the assay, which in the embodiment of FIG. 8C, is cholesterol (Chol). Means and predicted means of the assays at different levels may be displayed as shown in FIG. 8C. The column N is the number of test replicates performed at that level. For example, when N=5 and when the high concentration sample is selected, the analyzer performs serial dilutions creating five levels, such as: 0%, 25%, 50%, 75%, and 100% of the high concentration. These are the “levels” that are tested. A progress summary may include a dilution ID with the replicates and the observed mean. Other tables may also be displayed. In addition, the study results 800C may display a graph 832 of the observed mean versus the predicted mean. The study results 800C may also display items related to the graph 832 including slope, intercept, correlation coefficient, and a measuring interval. Other information may be displayed. The study may be saved and/or printed. For example, the information entered by the user may be saved and run automatically by the controller 114 at a later time.

Referring again to FIG. 4, the user may select the bubble 402E to cause the controller 114 to perform the manual MIV study, which may provide an assessment of measuring intervals using three or more samples with assigned targets and ranges throughout the measurement range. The manual MIV study may verify the calibration of the selected assay. The study may be based on CLSI EP-06 titled, Evaluation of the Linearity of Quantitative Measurement Procedures. Individual targets and ranges can be entered. The workstation 228 (FIG. 2) may then cause the display 228A to display a GUI (not shown) that may enable the user to enter information to perform the manual MIV study similar or identical to the GUI 800A of FIG. 8A. Another GUI may be displayed that is similar or identical to the GUI 800B of FIG. 8B that enables the user to enter additional information into the controller 114.

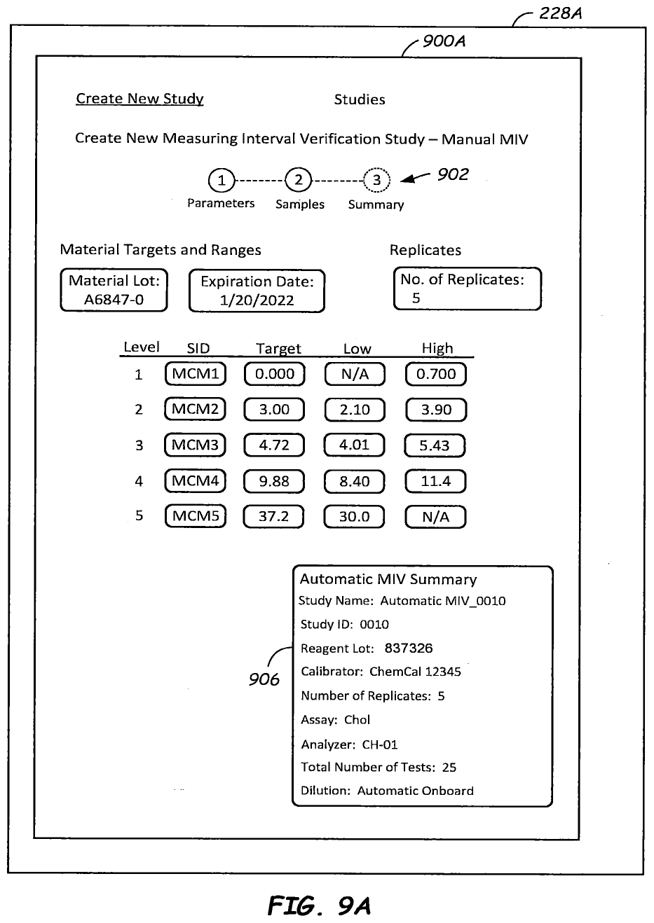

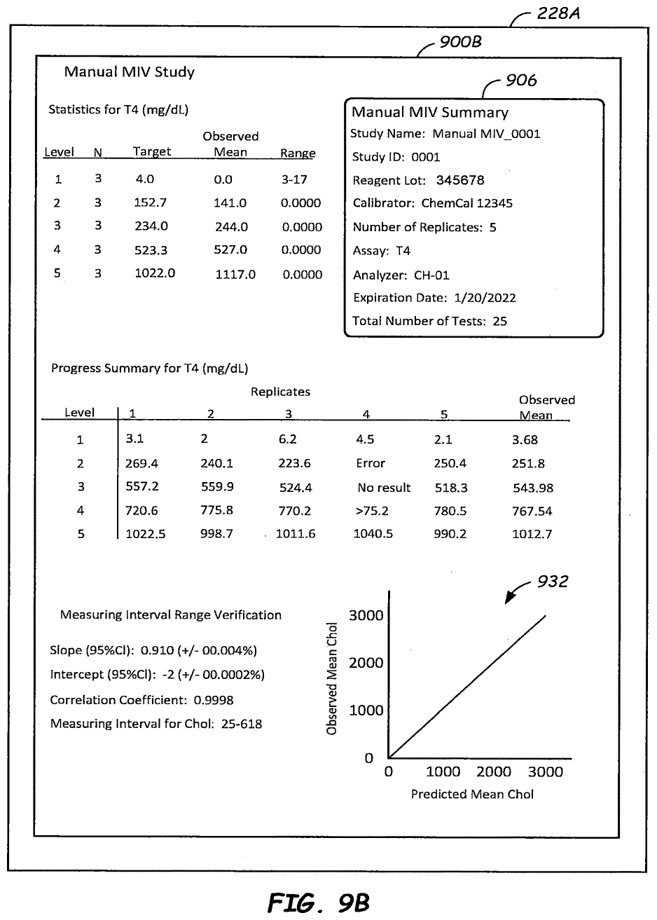

After the aforementioned information is entered into the controller 114 via the aforementioned GUI(s), the workstation 228 may cause the display 228A to display a GUI 900A as illustrated in FIG. 9A, which enables the user to enter values for SIDs, material lot, expiration date, and number of replicates used in the manual MIV study. Other information may be entered by way of the GUI 900A. The GUI 900A may include a progress bar 902 that may be identical or similar to the previously-described progress bars. The GUI 900A may also include a summary window 906 that may display information of values and other information related to running the manual MIV study.

As shown in FIG. 9A, the user may enter the SID, a target, a low value, and a high value for each level in the assay for the manual MIV study. In some embodiments, the user is not required to enter the target, high value, or low value to continue with the manual MIV study. When all information necessary for running the manual MIV study is entered, the user may instruct the controller 114 (FIG. 2) to run the manual MIV study. The controller 114 may then transmit instructions to the selected analyzer, wherein the instructions cause the selected analyzer to run the manual MIV study per the information entered by the user.

Reference is made to FIG. 9B, which illustrates an embodiment of the display 228A displaying study results 900B of the manual MIV study. The study results 900B may include statistics for the assay, which in the embodiment of FIG. 9B is T4. Information may include observed mean and statistics for the result recovered on the different levels of the selected assay, for example. In the embodiment of FIG. 9B, the T4 assay is selected. Other assays may be selected. In addition, the study results 900B may display a graph 932 showing the observed mean as a function of the predicted mean. Parameters of the graph 932, including slope, intercept, correlation coefficient, and the measuring interval may be displayed, for example. Other information may be displayed. The study may be saved and/or printed. In some embodiments, the information entered by the user may be saved and the manual MIV study may be run at a different time.

Referring again to FIG. 4, the user may select one of the precision studies. In the following description, the user has selected bubble 402F to run the simple precision study. The study may be based on the protocol described is CLSI EP-15, titled User Verification of Precision and Estimation of Bias. In the embodiment of FIG. 4, the simple precision study may test repeatability of up to three samples and provide, mean, SD, and CV for each of the samples. Other numbers of samples may be used. Repeatability of other numbers of samples may be used. When the bubble 402F is selected, the workstation 228 (FIG. 2) may cause the display 228A to display a GUI (not shown), such as the GUI 800A (FIG. 8A) and/or the GUI 800B (FIG. 8B), that enables the user to enter information to run the simple precision study.

In some embodiments, the user may enter information such as a study name, which may cause the GUI to autopopulate with a corresponding study ID. The user may also enter the analyzer on which the study is to be run. The user may also enter a single assay for the study. In some embodiments, the GUI may provide a menu with all the assays available for the analyzer. The user may then choose a number of replicates, such as between three and 100 replicates. The reagent packs available for that analyzer may then be displayed. The reagent packs may be the test materials.

The workstation 228 (FIG. 2) may cause the GUI to display information requesting the user to enter sample selections as described in the other studies. In some embodiments, the user may enter sample IDs if the user wants to use samples that are not stored in the controller 114, such as in the sample attributes database 120B (FIG. 2). In some embodiments, the user may scan barcodes or other identifiers of the samples to enter those samples into the controller 114. When a sample is entered or scanned, the sample is added to the database. In some embodiments, the user can select an icon to delete a sample from the database. When at least one sample is added, the GUI may display the number of tests needed to complete the study. In some embodiments, the GUI may disable the ability to add samples when a predetermined number of samples, such as three samples, has been entered.

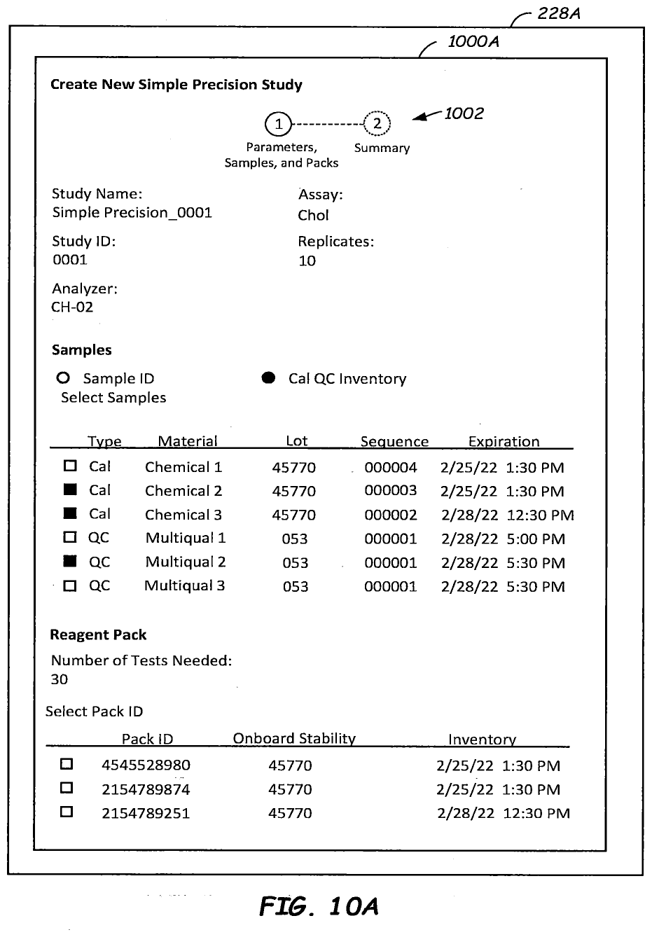

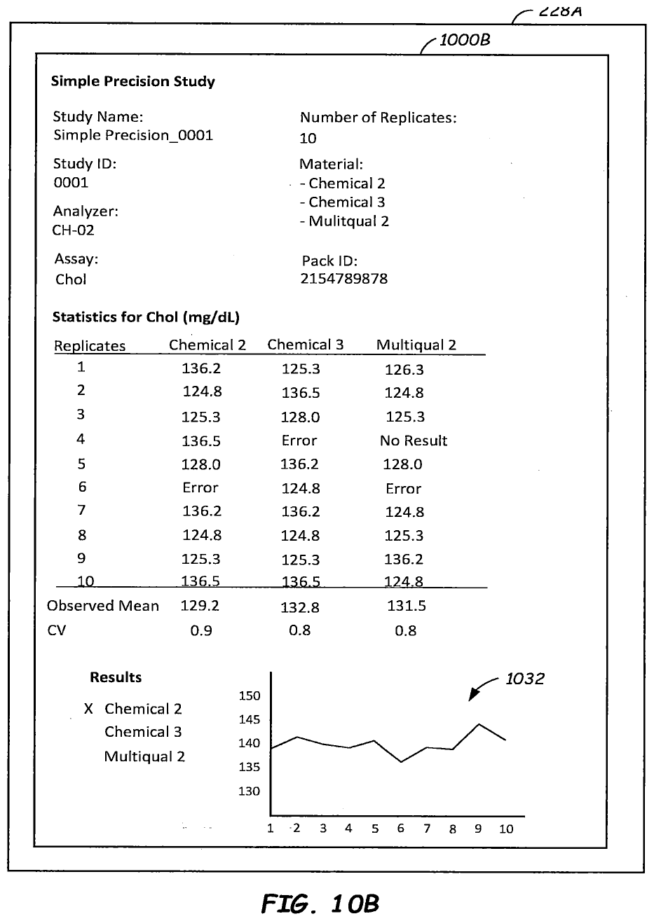

Reference is made to FIG. 10A, which illustrates a GUI 1000A displayed on the display 228A and configured to input information entered by the user to the controller 114 (FIG. 2) to run the simple precision study. In some embodiments, the GUI 1000A displays the reagent packs available on the selected analyzer for the selected assay that have at least the number of tests needed to perform the study. In some embodiments, reagent packs may be removed (e.g., not displayed) if the reagent packs do not have enough tests to support the study. In the embodiment of FIG. 10A, the GUI 1000A shows information displayed after the user has selected Cal QC inventory for the sample selection. The GUI 1000A may then list information about all calibrator and QC samples stored within Cal QC storage inventory that support the selected assay.

In some embodiments, such as shown in FIG. 10A, the list of reagent packs may display on the GUI 1000A after the analyzer and the assay have been selected. In some embodiments, the GUI 1000A may display all reagent packs that are onboard the selected analyzer and that are enabled. If at least one sample is selected, the controller 114 (FIG. 2) may calculate and cause the GUI 1000A to display the number of tests needed and the number of replicates to complete the simple precision study.

After the information is entered into the workstation 228 (FIG. 2), the controller 114 (FIG. 2) may cause the simple precision study to be run. Reference is made to FIG. 10B, which shows the display 228A showing an example of the study results 1000B. The study results 1000B may include a graph 1032 that may display selected information. In the embodiment of FIG. 10B, the graph 1032 is illustrated showing the results of the chemical 2 for each of the replicates. In some embodiments, the simple precision study may be saved. For example, the information of the study may be saved and run at a later date.

Referring again to FIG. 4, the user may select the bubble 402G to select the Within Lab Precision study. The primary reference used for the protocol described is CLSI EP-15, titled User Verification of Precision and Estimation of Bias. The lab precision study may provide analysis of variations with a predetermined number of replicates for a predetermined number of days. In some embodiments, the study may be run automatically over the selected time or number of replicates. The variations may be any of the chemicals described herein. In some embodiments, the number of replicates is five and the analyses is performed once per day for five days. Study results as described above may be displayed on the display 228A.

The above-described methods, laboratory system, and analyzers advantageously enable automated studies to be performed using the analyzers. Because the studies are automated, the users may perform other functions on the analyzers as the studies are being performed.

The GUIs described herein may provide other selection options. For example, tables of assays and other parameters may be presented rather than pulldown menus. A user may select an assay or parameter from a table. When the assay or other parameter is selected, the table may change to show the selection. For example, text or colors associated with selected assays or parameters may change. In addition, the GUIs and study reports described herein are not limited by the menus and other items displayed thereon. Accordingly, the GUIs and study reports may display other graphs, tables, menus, and the like.

In some embodiments, the controller 114 may analyze historical results to suggest samples that may be used in a study. The suggested samples may be presented to the user when parameters of the study are entered, for example. In some embodiments, a storage module, such as the storage module 231 (FIG. 2) in the sample handler 230 may store samples and/or test materials. These may be stored onboard in one or more of the analyzers 204, for example. The sample handler 230 may deploy materials automatically from the storage module 231 based on study schedules, such as predefined study schedules. In some embodiments, the QC parallel study, the within lab precision study, and the automatic MIV study may use stored onboard materials. Other studies may use the stored onboard materials.

In some embodiments, data may be compiled from one or more analyzers and/or from one or more diagnostic laboratory systems (e.g., more than one diagnostic laboratory system 100 that may be networked together). The data may be held in a common database (not separately shown), for example. Reports generated using such data may be stored in a central computer (e.g., using a data manager program associated with one or more laboratory systems). A graphical user interface (not separately shown) may allow access to the data and/or reports. For example, the graphical user interface may be displayed on the display 228A (FIG. 2). Centralized data storage enables data from one or more analyzers and/or from one or more laboratory systems to be used to identify samples and test materials that meet criteria for specific studies.

When a study is complete, the data generated by the study may be consolidated by a controller (e.g., controller 114) of the laboratory system and/or one or more analyzers into a report (e.g., a study report). A user may then be notified that the report is available for review, such as by an alert on display 228A (FIG. 2). Data may also be stored in a library, such as in a computer memory (e.g., memory 118) and/or one or more databases, so past studies and reports can be conveniently accessed in the future. In some embodiments, data from past reports and studies may be compared to track trends in the operations of analyzers and/or for other purposes. In one or more embodiments, data from past reports and studies may be accessed during regulatory inspections, such as to evaluate new test materials used during testing.

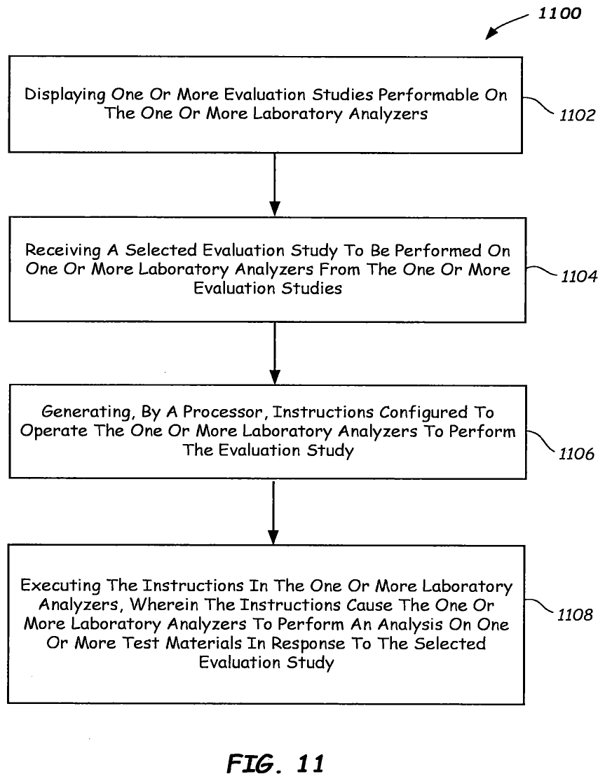

Reference is now made to FIG. 11, which illustrates a flowchart showing a method 1100 of performing a study using one or more laboratory analyzers (e.g., one or more of the analyzers 104). The method 1100 includes, in process block 1102, displaying on a display (e.g., display 228A) one or more evaluation studies performable on the one or more laboratory analyzers. The method 1100 includes, in process block 1104, receiving a selected evaluation study to be performed on the one or more laboratory analyzers from the one or more evaluation studies. The method 1100 includes in process block 1106 generating, by a processor (e.g., controller 114), instructions configured to operate the one or more laboratory analyzers to perform the evaluation study. The method 1100 includes, in process block 1108, executing the instructions in the one or more laboratory analyzers, wherein the instructions cause the one or more laboratory analyzers to perform an analysis on one or more test materials in response to the selected evaluation study.

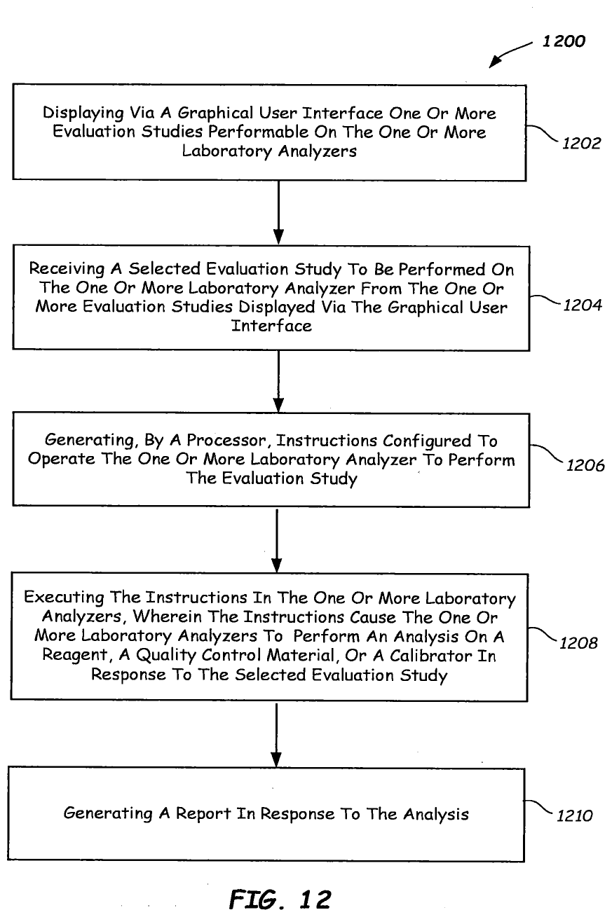

Reference is now made to FIG. 12, which illustrates a flowchart showing another method 1200 of performing a study using one or more laboratory analyzers (104). The method 1200 includes, in process block 1202, displaying via a graphical user interface (e.g., GUI 400) one or more evaluation studies performable on the one or more laboratory analyzers. The method 1200 includes, in process block 1204, receiving a selected evaluation study to be performed on the one or more laboratory analyzers from the one or more evaluation studies displayed via the graphical user interface. The method 1200 includes in process block 1206 generating, by a processor (e.g., controller 114), instructions configured to operate the one or more laboratory analyzers to perform the evaluation study. The method 1200 includes, in process block 1208, executing the instructions in the one or more laboratory analyzers, wherein the instructions cause the one or more laboratory analyzers to perform an analysis on a reagent, a quality control material, or a calibrator in response to the selected evaluation study. The method 1200 includes, in process block 1210, generating a study in response to the analysis.

While the disclosure is susceptible to various modifications and alternative forms, specific system and apparatus embodiments and methods thereof have been shown by way of example in the drawings and are described in detail herein. It should be understood, however, that this disclosure is not limited to the particular systems, apparatus, or methods disclosed but, to the contrary, this disclosure is to cover all modifications, equivalents, and alternatives falling within the scope of the appended claims below.

What is claimed is:

1. A method of performing a study using one or more laboratory analyzers, comprising:
displaying on a display one or more evaluation studies performable on the one or more laboratory analyzers;
receiving a selected evaluation study to be performed on the one or more laboratory analyzers from the one or more evaluation studies;
generating, by a processor, instructions configured to operate the one or more laboratory analyzers to perform the evaluation study; and
executing the instructions in the one or more laboratory analyzers, wherein the instructions cause the one or more laboratory analyzers to perform an analysis on one or more test materials in response to the selected evaluation study.

2. The method of claim 1, wherein the one or more evaluation studies include a comparison study between at least a first calibrator and a second calibrator and wherein a first of the one or more test materials is from the first calibrator and a second of the one or more test materials is from the second calibrator.

3. The method of claim 2, further comprising generating by a processor a report including differences between analyses using the first of the one or more test materials and analyses using the second of the one or more test materials.

4. The method of claim 1, wherein the one or more evaluation studies include a quality control parallel study, wherein a first of the one of the one or more test materials is from a first quality control material and a second of the one or more test materials is from a second quality control materials.

5. The method of claim 4, further comprising generating by a processor a report including differences between analyses using the one or more test materials from the first quality control material and analyses using the one or more test materials from the second quality control materials.

6. The method of claim 1, wherein the one or more evaluation studies include a comparison study between at least two different reagents, wherein a first of the one or more test materials is a first reagent and a second of the one or more test materials is a second reagent.

7. The method of claim 6, wherein the first reagent and the second reagent are used in the same assay by the one or more laboratory analyzers.

8. The method of claim 6, further comprising generating by a processor a report including differences between analyses of the first reagent and analyses of the second reagent.

9. The method of claim 1, wherein the one or more evaluation studies include a measuring interval verification study, wherein a first of the one or more test materials is a first dilution of a sample with a target of the analysis and wherein a second of the one or more test materials is a second dilution of a sample.

10. The method of claim 9, further comprising generating by a processor a report including differences between analyses of the first dilution of a sample and the second dilution of a sample.

11. The method of claim 1, wherein the one or more evaluation studies include a repeatability of one or more of the test materials.

12. The method of claim 11, further comprising generating by a processor a report including at least one of mean, standard deviation, and coefficient of variation based on the repeatability.

13. The method of claim 1, wherein the one or more evaluation studies include an analysis of variation of a predetermined number of replicates performed on the one or more test materials for a predetermined number of tests.

14. The method of claim 13, further comprising generating by a processor a report including variations in the repeatability over the predetermined number of tests that the analysis is performed.

15. The method of claim 1, further comprising generating by a processor a report in response to the analysis.

16. A laboratory system comprising:
one or more laboratory analyzers;
a display; and
a controller configured to:
generate instructions to display on the display one or more evaluation studies performable on the one or more laboratory analyzers;
receive user input selecting an evaluation study to be performed on the one or more laboratory analyzers from the one or more evaluation studies;
generate instructions configured to operate the one or more laboratory analyzers to perform the selected evaluation study; and
execute the instructions in the one or more laboratory analyzers, wherein the instructions cause the one or more laboratory analyzers to perform an analysis on one or more test materials in response to the selected evaluation study.

17. The laboratory system of claim 16, wherein the controller is further configured to generate instructions that cause the display to display at least one result of the study.

18. The laboratory system of claim 16, wherein the one or more test materials includes a reagent.

19. The laboratory analyzer of claim 16, wherein the one or more test materials includes a calibrator.

20. A method of performing a study using one or more laboratory analyzers, comprising:
displaying via a graphical user interface one or more evaluation studies performable on the one or more laboratory analyzers;
receiving a selected evaluation study to be performed on the one or more laboratory analyzers from the one or more evaluation studies displayed via the graphical user interface;
generating, by a processor, instructions configured to operate the one or more laboratory analyzers to perform the evaluation study;
executing the instructions in the one or more laboratory analyzers, wherein the instructions cause the one or more laboratory analyzers to perform an analysis on a reagent, a quality control material, or a calibrator in response to the selected evaluation study; and
generating a report in response to the analysis.
